(19) United States
(12) Patent Application Publication
(10) Pub. No.: US 2023/0252264 A1
(43) Pub. Date: Aug. 10, 2023

(54) NEURAL NETWORK PROCESSING

(71) Applicant: Arm Limited, Cambridge (GB)

(72) Inventors: Daren Croxford, Swaffham Prior (GB); Rachel Jean Trimble, Grindleford (GB); Sharjeel Saeed, Cambridge (GB); Roberto Lopez Mendez, Cambridge (GB)

(73) Assignee: Arm Limited, Cambridge (GB)

(21) Appl. No.: 17/669,301

(22) Filed: Feb. 10, 2022

(51) Int. Cl. G06N 3/04; G06V 10/82

(52) U.S. Cl. CPC G06N 3/04; G06V 10/82

(57) ABSTRACT

When executing a neural network comprising a sequence of plural layers of neural network processing in which at least one of the layers of the sequence of plural layers of the neural network is followed by two or more branches of neural network processing, each branch comprising a different sequence of one or more layers of neural network processing, the branch or branches to use for the neural network processing following the layer of the neural network that is followed by the two or more branches of neural network processing is selected based on a property or properties of the output feature map from the layer that is followed by the two or more branches.

### BACKGROUND

The technology described herein relates to the execution of neural networks in electronic devices.

Neural networks can be used for processes such as machine learning, computer vision and natural language processing operations.

Neural network processing generally comprises a sequence of operations (which may be referred to as “layers” of the neural network processing), which each process an input feature map to provide an output feature map (which may become the input feature map for another operation (layer)). The sequence of operations (layers) may, for example, be able to process complex data (e.g. image or sound data) to ultimately provide a desired output (e.g. an indication of an object within an image or a spoken word within a sound clip, or other useful output inferred from the input data).

The input data arrays which are processed by operations (layers) during neural network processing are commonly referred to as “input feature maps”. Likewise, the output data arrays generated from input data arrays by operations (layers) during neural network processing may be referred to as “output feature maps”. The input/output data arrays (feature maps) will typically comprise arrays of data which are derived from (representative of) part of, or the entirety of, data initially provided to the neural network (e.g. image or sound data) and that is to be processed by the neural network.

The Applicants believe that there remains scope for improvements to neural network processing and to systems which perform neural network processing, for example to increase the efficiency of neural network processing.

### BRIEF DESCRIPTION OF THE DRAWINGS

A number of embodiments of the technology described herein will now be described by way of example only and with reference to the accompanying drawings, in which:

FIG. 1 shows an exemplary sequence of layers of neural network processing comprising an input layer and an output layer, between which are neural network layers comprising various convolutional layer (C-layer) layers and fully-connected layers (FC layer);

FIG. 2 shows schematically further details of an exemplary data processing system within which embodiments of the technology described herein may be implemented;

FIG. 3 shows schematically further details of an exemplary data processing system within which embodiments of the technology described herein may be implemented;

FIG. 4 shows schematically the handling of data for neural network processing in embodiments of the technology described herein;

FIG. 5 shows an exemplary embodiment of a neural network that is in accordance with the technology described herein;

FIG. 6 shows aspects of the execution of a neural network having the form shown in FIG. 5 in embodiments of the technology described herein;

FIGS. 7 and 8 illustrate a first embodiment of a neural network that can be executed in accordance with the technology described herein;

FIGS. 9 and 10 illustrate another embodiment of a neural network that can be executed in accordance with the technology described herein;

FIG. 11 shows further aspects of the execution of neural networks in embodiments of the technology described herein; and

FIGS. 12 and 13 show exemplary embodiments of the distribution of neural network processing to different processors in embodiments of the technology described herein.

Like reference numerals are used for like features in the drawings (where appropriate).

### DETAILED DESCRIPTION

A first embodiment of the technology described herein comprises a method of operating a data processing system, the data processing system comprising one or more processors operable to execute neural network processing, and memory for storing data relating to the neural network processing being performed by the one or more processors, the method comprising:

one or more of the one or more processors executing a neural network comprising a sequence of plural layers of neural network processing to process an initial input data set to generate a final output data set that is the result of processing the initial input data set using the neural network;

wherein:

at least one of the layers of the sequence of plural layers of the neural network is followed by two or more branches of neural network processing, each branch comprising a different sequence of one or more layers of neural network processing, whereby the neural network processing from the layer that is followed by two or more branches of neural network processing onwards can be selectively performed via one or more of the different branches of neural network layers;

the method further comprising, when executing the neural network:

for a layer of the neural network that is followed by two or more branches of neural network processing, selecting the branch or branches to use for the neural network processing from that layer onwards based on a property or properties of the output feature map from the layer that is followed by the two or more branches.

A second embodiment of the technology described herein comprises a data processing system, the data processing system comprising:

one or more processors operable to execute neural network processing;

memory for storing data relating to the neural network processing being performed by the one or more processors; and

a processing circuit configured to:
when one or more of the one or more processors is executing a neural network comprising a sequence of plural layers of neural network processing to process an initial input data set to generate a final output data set that is the result of processing the initial input data set using the neural network, and
at least one of the layers of the sequence of plural layers of the neural network is followed by two or more branches of neural network processing, each branch comprising a different sequence of one or more layers of neural network processing, such that the neural network processing from the layer that is followed by two or more branches of neural network processing onwards can be selectively performed via one or more of the different branches of neural network layers:

select the branch or branches of neural network processing to use for the neural network processing following a layer of a neural network that is followed by two or more branches of neural network processing, based on a property or properties of the output feature map from the layer that is followed by the two or more branches of neural network processing.

The technology described herein relates to neural network processing, in which a neural network comprising a sequence of plural layers is used to process an initial input data array to generate a final output data array of the neural network processing.

However, in the technology described herein, at least one of the layers of the neural network is followed by two or more possible branches or paths for the neural network processing that can be selected, each comprising a different sequence of one or more layers of neural network processing.

For example, and in one embodiment, one branch or path may comprise relatively simpler, and/or a reduced number of, layers of neural network processing (to thereby allow the neural network processing to be completed more quickly and/or with less processing requirements if that path (branch) is selected), with the other branch (path) of the neural network processing comprising more, and/or more complex, layers of neural network processing that will accordingly have a higher processing burden and/or time, but that may be expected to, and in an embodiment does, provide a more reliable and/or accurate neural network processing result than another branch (path) that may be selected.

The branch (path) of neural network processing to use for a given output from the preceding layer (e.g., and in an embodiment, whether to take the “simpler” or more “complex” branch) is then selected based on a property or properties of, such as, and in an embodiment, the relative information entropy of, the output data from the layer that is followed by the branches.

The Applicants have recognised in this regard that certain inputs to a neural network and within a neural network may be able to be processed using a, e.g., simpler neural network than other inputs, whilst still resulting in the same end result (output from the neural network) and with a sufficiently high level of accuracy/certainty. In particular, it can be possible to process less complex feature maps using less complex (and thereby more efficient) sequences (layers) of neural network processing, whilst still providing the desired and correct end result (which would be achieved when processing that data using a more complex neural network) and with a sufficient level of certainty.

The Applicants have furthermore recognised that the opportunity to subject data to different, e.g., and in an embodiment, less complex, neural network processing can be identified based on a property or properties of the data itself.

The technology described herein exploits this by using a neural network that includes two or more branches, each comprising different sequences of neural network processing, and then selecting which branch to use for a given output at the layer in question based on (at least) a property or properties of, such as the relative information entropy of, the data. This then facilitates, for example, and in an embodiment, identifying data that can accordingly be processed using a “simpler” sequence of neural network processing (a “simpler” branch of the neural network), whilst still allowing other data to be processed using a, e.g. more complex, sequence of neural network processing. Correspondingly, the technology described herein facilitates identifying data that can be processed using a, e.g. simpler, sequence of neural network processing (and then processing that data using the, e.g. simpler, sequence of neural network processing) where it is possible to do that.

The technology described herein accordingly facilitates identifying, and then exploiting, opportunities where data for neural network processing can be “safely” subjected to different, e.g., and in an embodiment less complex, neural network processing, without (substantially) affecting the end result of the neural network processing. Accordingly, the technology described herein can provide a more efficient neural network and more efficient neural network processing, by identifying and taking opportunities to reduce the amount of neural network processing that is performed when processing data using a neural network. This will correspondingly reduce the neural network processing and power usage burden, etc., on the electronic device that is executing the neural network.

The data processing system of the technology described herein may be implemented as part of any suitable electronic device which may be required to perform neural network processing, e.g., such as a desktop computer, a portable electronic device (e.g. a tablet or mobile phone), or other electronic device. Thus the technology described herein also extends to an electronic device that includes the data processing system of the technology described herein (and on which the data processing system operates in the manner of the technology described herein). The data processing system of the present may, in an embodiment, be implemented as part of a portable electronic device (such as a mobile phone, tablet, or other portable device).

The data processing system may comprise any desired components and elements that a data processing system can comprise, such as one or more or all of: a display processing unit (display processor), a central processing unit (CPU), a graphics processing unit (GPU) (graphics processor), a video processor, a digital signal processor, one or more neural network processors (NPUs), a display and a memory.

The processors may be arranged within a system-on-chip system.

Correspondingly, the processor or processors that executes the neural network may comprise any suitable processor(s) that is capable of doing that, such as a central processing unit (CPU), a graphics processing unit (GPU) (graphics processor), a video processor, a sound processor, an image signal processor (ISP), a digital signal processor, and a Neural Network Accelerator/Processor (Neural Processing Unit (NPU)). The processor(s) should, and in an embodiment does, include appropriate processing circuits, logic, etc., suitable for performing neural network processing operations.

There may be a single processor that is executing the neural network or plural processors that execute the neural network, as desired (and different numbers of processors may be used at different times).

The memory of the data processing system may comprise memory for storing data, inter alia, relating to neural network processing. For example, the memory may store data for input data arrays, output data arrays, and weight data arrays. The memory may comprise one or more local memories, which may be located on-chip. The local memory may comprise one or more caches.

The memory may also comprise a main memory, which may be an external memory which may be located off-chip. The main (external) memory may be any suitable type of memory, such as SDRAM for example.

The data processing system (and in particular the processors of the data processing system) may be operable to access data which is present in a local memory (cache) when performing neural network processing. The data processing system may be operable to request data to be transferred from main (external) memory to local memory if data that is required is not already present in the local memory. The data processing system may comprise one or more circuits for transferring data from main memory to local memory (and for transferring data from local memory to main memory), e.g. such as one or more a direct memory access (DMA) units which may be associated with the processor which is to perform the neural network processing.

The technology described herein may be used in conjunction with any suitable and desired neural network and neural network processing. In an embodiment, the neural network is a convolutional neural network.

The overall input (initial input data set) which is to be processed by the neural network (and subject to the neural network processing) can correspondingly be any suitable set of input data that may be processed by a neural network, such as, for example, an image (e.g. from an image signal processor (ISP), or an image frame from video data), sound data (e.g. voice data), or other input data. Correspondingly, the neural network processing which is to be performed may contribute to identifying or classifying features present within the initial input data set, such as objects in an input image, or sound features in input sound data.

The overall initial input, e.g. image, may be processed in its entirety through each layer of the neural network processing (e.g. in turn), or the overall initial input may be processed as a plurality of small portions (e.g. tiles) making up the overall input data set, as desired. In the latter case, each portion (tile) of the overall input data set may be, and is in an embodiment, respectively processed in the manner of the technology described herein.

The final output data set (which is the result of processing the initial input data set using the neural network) may correspondingly comprise any suitable and desired output that a neural network and neural network processing may produce. The final output may be written to memory, or may be provided directly to a processor for use as an input data set, for example when processing a subsequent layer of neural network processing.

It would also be possible for the initial input data set that is subjected to the neural network processing in the manner of the technology described herein to be an intermediate data set of some overall, larger, sequence of neural network processing, with the final output data set that is the result of processing the initial input data set using the neural network in the manner of the technology described herein again correspondingly being able to be an intermediate output data set that is then, e.g., able to be subjected to further, e.g. neural network processing.

Correspondingly, the technology described herein is applicable whether the neural network (the sequence of plural layers of neural network processing) being executed is the entirety of the neural network (processing) that is to be executed, or only a portion (a subset) of an overall neural network that is to be executed.

The neural network that is being executed in the technology described herein should, and in an embodiment does, comprise a sequence of layers of neural network processing. The network may comprise any desired (plural) number of layers.

Each layer of the sequence of plural layers of the neural network should, and in an embodiment does, process, input data, e.g. an input feature map (or maps), to that layer to thereby generate an output, e.g. output data, such as a probability, a feature map (or maps), etc., that is the output of the layer in question. The layers may perform any suitable and desired neural network processing operation or operations, such as a convolution operation, a de-convolution operation, a pooling operation, an activation operation, an elementwise operation, fully connected layer, etc.

A convolution/deconvolution layer, for example, generates and processes feature maps. Each input feature map to a layer of neural network processing will comprise an appropriate single- or multi-dimensional (and in an embodiment multi-dimensional, e.g. three-dimensional) tensor, comprising one or more, and in an embodiment plural, data positions, with each data position having one or more data values associated therewith.

Correspondingly, an output feature map from a layer of the neural network processing will correspondingly comprise an appropriate single- or multi-dimensional tensor. In embodiments, and as will be discussed further below, the output feature map from one layer of the sequence of plural layers of the neural network processing is used as an input feature map to a (and in an embodiment to the) next layer in the sequence of plural layers of the neural network processing.

In the technology described herein, (at least) one of the layers of the sequence of plural layers of the neural network is followed by two or more branches of neural network processing, such that the neural network processing from that layer onwards can be selectively performed via one or more different branches of sequences of neural network layers.

There may in this regard be only a single branching point in the sequence of plural layers of the neural network (i.e. only one layer in the sequence of plural layers of the neural network that is followed by two or more branches of neural network processing), or there may, if desired, be plural branching points in the sequence of plural layers of the neural network processing (i.e. such that plural ones of the layers of the sequence of plural layers of the neural network processing are followed by two or more branches of neural network processing), as desired. Equally, a given branch or branches could themselves include (further) branching points, if desired.

The technology described herein is applicable regardless of how many branching points there are in the sequence of plural layers of the neural network processing, and can be, and is in an embodiment, used for any and all branching points in a given sequence of plural layers of neural network processing.

The technology described herein will primarily be described below with reference to the configuration and operation for a respective individual branching point (layer followed by a set of plural branches), but it will accordingly be understood that the operation and features of the technology described herein described below are applicable for any and all branching points (layers followed by plural branches) in any given sequence of plural layers of neural network processing.

A branch point may comprise two branches only (i.e. such that the layer of the sequence of plural layers of the neural network is followed by (only) two branches of neural network processing) (and in one embodiment this is the case). In this case therefore, the neural network processing from the branch point (i.e. after the layer that is followed by the branch point) will be able to be selectively performed either via a first branch comprising a first sequence of one or more neural network layers, or via a second, different branch, consisting a second, different sequence of one or more neural network layers, or via both the first and second branch.

It would also be possible for there to be more than two branches of neural network processing at a given branch point. For example, a layer may be followed by three (or more) branches of neural network processing that can be selectively used for neural network processing after the layer before the branch point. In this case, the three (or more) branches may, for example, comprise branches that are configured for processing input feature maps that have one of three (e.g.) different relative levels of information entropy (for example), and/or, as will be discussed further below, one or more of the branches may be tailored for particular processing hardware (and thus used in the event that such hardware is available for executing the neural network).

Each branch of neural network processing that is provided at a branch point of the neural network should, and in an embodiment does, comprise a different sequence of one or more neural network layers to the other branch or branches at the branch point in question. Thus each branch (at a given branch point) is in an embodiment configured as, and to perform, a different sequence of layers of neural network processing.

Each branch of neural network processing (at a given branch point) could be configured to and operate to perform a different overall neural network processing operation.

In an embodiment, the overall aim of the processing for each branch (at a given branch point) is the same (e.g. to identify a particular type or class of object in an image), but the actual sequence of processing (and neural network layers) to achieve that common aim is different for each branch.

For example, in an embodiments, the overall aim of the processing for each branch (at a given branch point) to perform one of: image recognition, image enhancement, super resolution, image segmentation, classification, or region based segmentation, but the actual sequence of processing (neural network layers) to achieve that is different for each branch. For example, for image recognition, one branch may have one or more convolution layers followed by fully connected layers, whereas another (simpler) branch may comprise just a few fully connected layers.

The different branches of neural network processing can differ from each other in any suitable and desired manner. In an embodiment they differ from each other in terms of the number of layers of neural network processing that are required for each branch. In an embodiment, the branches also or instead, and in an embodiment also, differ from each other in terms of the type(s) of layers of neural network processing that they include (i.e. such that each branch will include layers that are different to the layers in the other branch or branches (at the branch point in question)). The branches may also or instead differ from each other in respect of the order of the layers of neural network processing that they include.

In an embodiment, the different branches of neural network processing differ from each other in terms of the resources that they require to process (with one branch, e.g., requiring fewer resources to process than another branch). One branch may, for example, be computationally less intensive than another branch.

The branches could also or instead, and in an embodiment also, differ from each other in terms of the feature map size and/or the number of feature maps for a layer or layers in the branches. They could also or instead differ from each other in terms of one or more or all of: the data types used by/produced by the layers; the number of kernels used by the layers; the kernel size or sizes for the layers; whether they include depth-wise separable layers; the level of striding or downsampling used for the layers; the resolution of the data values to be processed for the layers (e.g. 8 vs 16 bit); how the layer(s) are divided up; or any other properties of the layers of neural network processing that may, for example, result in computationally less expensive processing (albeit potentially at the cost of accuracy).

In an embodiment, one of the branches is a main or primary branch of the neural network processing and that will, accordingly, normally be expected to be followed when executing the neural network, with the other branch or branches being a secondary branch that, in an embodiment, will be less likely to be followed, and that will, in particular, only be followed if a particular condition or conditions (relating to a property or properties of the output feature map (immediately) preceding the branch point) are met. In this case, the primary branch in an embodiment performs more complex neural network processing relative to the secondary branch.

Thus in an embodiment, there is a main or primary branch, which will be the “default” branch (that is followed in the normal or expected course of the neural network execution) with the other branch or branches then being branches that will be followed under specific (and in an embodiment a limited set of) conditions.

In an embodiment one of the branches is relatively simpler than another (or the other) of the branches, e.g., and in an embodiment, in terms of the processing that the branches will perform (and correspondingly the resources that the branches will use when being executed, e.g. in terms of execution units, memory, memory bandwidth, etc.).

Thus in an embodiment, one of the branches (the main/primary branch) is relatively more complex in terms of the neural network processing that it performs and an or the other of the branches (the secondary branch(es)) is relatively simpler in terms of the neural network processing that it performs.

Correspondingly, in an embodiment, one of the branches is relatively more expensive in terms of the resources that will be used when the branch is being executed, and an or other of the branches is relatively less expensive in terms of the processing resources that the branch will use when being executed.

This could, for example, simply be in terms of the number of layers of neural network processing that the branches include (for example with the simpler/less expensive branch including fewer layers than the more complex/more expensive branch), but it could also or instead be in terms of the types of layers (the operations that the layers perform) in the different branches.

In one embodiment, there is a branch (which will be a more “complex” branch) that includes relatively more convolution operations than an or the other of the branches. Correspondingly, in an embodiment, there is a branch that includes relatively more fully connected layers than an or the other of the branches. In an embodiment, there is a branch that includes and performs relatively more convolution layers and relatively fewer fully connected layers and vice-versa.

In one embodiment, there is a branch (which will be a more “complex” branch) that includes and performs one or more convolution operations. This branch in an embodiment does not include or includes only a few, fully connected layers. Correspondingly, in an embodiment, there is a branch that includes a fully connected layer or layers (and in an embodiment does not include any, or only a few, convolution layers) (which will then correspondingly be a relatively “simple” branch).

In an embodiment, where both (or all) branches perform the same overall processing operation (e.g. to identify a particular type of object in an image), one of the branches is a less resource intensive branch than another or the other of the branches, and which can therefore provide, and be configured to provide, an “early exit” (termination) from the neural network processing for data that is sent down that branch. This may, and in particular, be used to provide an “early exit” branch from the neural network processing where some or all of the output feature map from the layer preceding the branch point can be identified as being suitable for processing in a less complex manner (e.g., and in an embodiment, because it may be able to be identified that there is unlikely to be anything of interest in a region or regions of the output feature map, or in the output feature map as a whole).

In an embodiment, one or more of the branches is also or instead, and in an embodiment also, configured so as to be more suited for execution on a particular form of processor (and/or processing circuit hardware) that may execute the neural network and perform neural network processing. This may be in terms, for example, of what operations and/or functions required for neural network processing a processor/processing circuit(s) may be more suited to perform (more efficiently), the (relative) storage capacity (e.g. buffer size) that the processor/processing circuit(s) supports or can use, the memory access capability/resources that the processor/processing circuit(s) has, etc.

For example, a branch may preferentially or only include convolution layers (and not include or include only a very few fully connected layers), so as to make that branch more suited for execution on a neural processing unit (NPU) (and in one embodiment this is the case). Correspondingly, a branch may be configured to preferentially or only comprise fully connected layers (and to not include any, or only to include a few, convolution layers), so as to make that branch more suited for execution on something other than a neural processing unit (NPU), such as on a graphics processing unit (GPU) or central processing unit (CPU). It would also be possible to configure branches to be more optimised for execution on particular processing circuits (hardware) that a given processor may comprise (rather than an overall processor itself), if desired.

This may then facilitate using the branch selection opportunity to facilitate more efficient processing of the neural network on the available processor/hardware (circuits) for executing the neural network where that can be done.

As discussed above, there may in some circumstances be three or more branches of neural network processing possible at a branch point. In this case, the three or more branches can differ from each other in any one or more or all of the manners discussed above. Thus the branches may differ from each other in terms of the relative complexity of the neural network processing that they perform (and/or the resources that they require for performing the neural network processing). The different branches may also or instead differ in terms of the processor and/or hardware resources that they are more optimally executed on.

Other arrangements would, of course, be possible.

When a layer of the sequence of plural layers of the neural network is followed by two or more branches of neural network processing (i.e. a branch point in the neural network is reached), in the technology described herein the branch or branches to use for the neural network processing from that point onwards is selected based on a property or properties of the output feature map from the layer that is followed by the two or more branches (i.e. that precedes the branching point).

It would be possible in this regard for the operation to be configured such that only a single branch can be selected for the neural network processing from the branch point onwards (in which case the entirety of the output feature map from the layer that is followed by the branch point will be processed according to that (single) selected branch).

In an embodiment, the system and operation is configured such that more than one branch can be selected to use for neural network processing from the branch point onwards. In this case therefore, and in an embodiment, the processing from the branch point onwards could be selected to use only a single branch of the available branches, or plural branches of the available branches (e.g., and in an embodiment, two or all of the available branches) following the branch point.

In the case where plural branches can be selected and used for the neural network processing from a branch point onwards, then it would be possible to process the entire output feature map from the layer that precedes the branch point down one or each of the selected plural branches (in dependence upon whether one or plural branches are selected).

However, in an embodiment, where plural branches can be selected and used for the neural network processing following a branch point, different parts (regions) of the output feature map from the layer preceding the branch point can be, and in an embodiment are, sent down (processed using) different ones of the plural branches.

In this case therefore, a first part or parts (region or regions) of the output feature map from the layer preceding the branch point will be processed using a first one of the branches at the branch point, and a second, different, part or parts (region or regions), of the output feature map will be processed using a second, different branch of the branches following the branch point, and, so on, where there are more than two branches at the branch point (and it is selected to use more than two branches for the neural network processing following the branch point).

Thus, in an embodiment, the method of the technology described herein comprises (and the processor and processing circuit is correspondingly configured to) process a part of an output feature map from the layer that is followed by the two or more branches of neural network processing using one (a first) branch of the plural branches, and processing another, different part of the output feature map from the layer that is followed by the branches, using another (a second), different branch of the plural branches.

The branch or branches to use for the neural network processing from the branch point onwards is selected based on a property or properties of the output feature map from the layer that is followed by the two or more branches. In the case where only a single branch is selected (and the entire output feature map is processed using that selected, single branch), then a property or properties of the output feature map as a whole is in an embodiment considered for the selection process.

On the other hand, where different parts (regions) of the output feature map can be processed using different ones of the branches, then in an embodiment a property or properties of respective parts (regions) of the output feature map are considered, with the branch to use for the part of the output feature map in question then being selected based on the relevant property or properties of that part of the output feature map.

Thus, in an embodiment, when selecting the branch or branches to use for the neural network processing from a branch point onwards, the selection is made for respective parts of the output feature map individually (and independently), based on the relevant property or properties of the part of the output feature map itself.

Thus, in an embodiment, the output feature map from the layer that precedes the branching point is processed as a plurality of separate parts (that each comprise some but not all of the output feature map), and for each part the branch to use for the neural network processing for that part of the output feature map is selected based on a property or properties of that part of the output feature map. Correspondingly, a property or properties of a first part of the output feature map will be used to select the branch to use for the neural network processing for that part of the output feature map, and then a property or properties of a second, different part of the output feature map will be used to select the branch to use for the neural network processing for that part of the output feature map (and so on, as desired).

The different parts of the output feature map that are considered in this regard (and that can therefore be selectively sent down different branches of the neural network processing independently of other parts of the output feature map) can be selected as desired, and may be any suitable and desired subdivision of the output feature map from the layer preceding the branching point.

In an embodiment, each part is the same size and configuration (e.g. in terms of the number and layout of data elements of the output feature map that they comprise). For a feature map that is a 3D tensor, each part that is considered in an embodiment comprises a respective cuboid of the output feature map.

At least in the case of convolution/deconvolution layers, the different parts of the output feature map that are considered in this regard (and that can therefore be selectively sent down different branches of the neural network processing independently of other parts of the output feature map) correspond to the data in the receptive field (h*w*c) from the previous layer. Thus, the output from the previous layer will be divided into different parts (regions) based on the size of the receptive field. (On the other hand, for fully connected layers, for example, in an embodiment the entire output from the previous layer is sent down the same branch for processing.)

The property or properties of the output feature map or output feature map part that is used to select the branch to use (that the selection of the branch to use is based on) can be any suitable and desired property or properties of the output feature map/output feature map part on which the branch selection could be based. This may depend, for example, upon the different “properties” of the branches (the way in which the branches differ from each other), with the selection then being made based on whether the property or properties of the output feature map (part) is more appropriate for one branch or another.

It would be possible in this regard to base the branch selection on a single property of the output feature map/output feature map part, or on plural properties of the output feature map/output feature map part, as desired.

In an embodiment, a or the property of the output feature map/part on which the selection of the branch to use is based is a measure based on the content (the data values) of the output feature map (part). In an embodiment, a measure of how “complex” the output feature map (part), is, in an embodiment in terms of its data values, is used. This may then act as an indicator of whether, for example, that output feature map (part) should be subjected to more or less complex processing going forwards (e.g., and in particular, whether the next stage of the neural network processing to obtain the desired result of that stage of the neural network processing may require more or less complex neural network processing to achieve a sufficiently high level of accuracy/reliability).

In an embodiment, it is determined whether an output (e.g. output feature map) is relatively simpler or more complex, with the branch selection being made accordingly, e.g. in the case where the output (region of the output) is determined to be relatively simpler, a branch that uses fewer processing resources (e.g. includes fewer convolutional and/or deconvolution layers) is in an embodiment used (and vice-versa for an output or a region of an output that is determined to be more “complex”).

For example, where an input feature map is processed with a kernel to generate an output feature map channel, then the result of the application of the kernel to the feature map (i.e. the value in the output feature map channel) may be used as a measure of the, e.g. “complexity” of the output feature map part to thereby assist the branch selection decision. For example, if the processing (the kernels) is configured to identify edges in an image, and the specific output feature map channel that is looking for edges is all 0 (or all small values), that would indicate that there are fewer edges in that region and so that region is less complex (in terms of the “edges” that are the features being sought).

Thus in an embodiment, the value for one, or some or all, of the kernels for a region (or indeed the whole input) can be, and is in an embodiment used to infer complexity for that region, etc.

In an embodiment, the branch selection is based on a measure of the variability of the data values of in the output feature map (part), and in an embodiment on a measure of the information entropy of the output feature map (part) (a measure of the overall entropy of the output feature map (part)) for which the branch selection is being made).

A measure of the variability/entropy in the output feature map (part) can be determined in any suitable and desired manner, and be based on any suitable and desired (measurable) property of the output feature map (part).

In one embodiment, the property or properties of the output feature map (part) that is used to determine which branch or branches to use comprises a property or properties relating to compression of the output feature map, and in an embodiment relating to the relative compressibility (or otherwise) of the output feature map (part). In an embodiment, one branch is taken for (parts of) output feature maps that are determined to be more compressible, with another branch being selected for (parts of) output feature maps that are relatively less compressible.

Any suitable and desired measure of the relative compressibility of (part of) an output feature map can be used for this purpose. In one embodiment, the compressed data size (the size of the output feature map data after compression) and/or the compression ratio, of the (part of the) output feature map is used as the property on which the selection of the branch to take is based.

The Applicants have recognised in this regard that the relative compressibility may be a good indicator of the variability (entropy) of the data in the output feature map (as if the output feature map (part) comprises lots of the same data values and/or small data values, then the output feature map (part) will be likely to compress well (and thus have a smaller compression data size/higher compression ratio).

Other properties of the (part of the) output feature map, as well as or instead of a measure of the relative compressibility, could be used if desired (e.g. in the case where the output feature map is not to be compressed in any event). For example, one or more of: an indication of whether all or part of the output feature map is all zeros and/or all has the same value; (an indication of) the distribution of the data values in the output feature map part, such as an indication of the range of values in a (part of) the output feature map; a measure of the number of zeros (or other particular data value) in, or a histogram of the data values for, the (part of the) output feature map; and/or whether the feature map contains values above a particular, in an embodiment selected, in an embodiment predetermined, threshold value, could be generated and used as a property or properties on which to base the branch selection.

It would also be possible, for example, to use information indicative of the content of the output feature map, such as a content-indicating signature or signatures, such as a CRC or hash or other content dependent value that can be derived from the data values of the output feature map for the branch selection. For example, a particular set of data values for a region of an output, e.g. output feature map, e.g. in the case where all the values are the same, may correspondingly result in a particular content-indicating signature value, such that particular, e.g. selected, signature values can be taken as being indicative of particular, corresponding, specific properties of the region that the signature relates to, and then used for the branch selection. This could be based, for example, on detecting the presence of a particular signature value, and/or groups of signature values (e.g. that are considered to be indicative of regions potentially of less interest).

The property or properties of the output feature map can be determined and assessed in any suitable and desired manner. In an embodiment, the property or properties is determined and assessed from metadata relating to the output feature map (and that is indicative of the property or properties in question). In this case, the metadata could be, and in an embodiment is, metadata that is otherwise generated for the output feature map anyway (for another purpose), or it could be metadata that is specifically generated from an analysis of the output feature map to indicate the (value of the) property or properties of the output feature map (part).

For example, in the case where the output feature map is to be compressed, e.g. for storage, in any event, then appropriate compression data/information that is derived as part of the intended and normal compression process could also be used for the purposes for selecting the branch to take in the manner of the technology described herein. In the case where the output feature map is not intended to be compressed, then it would in any event be possible to process the output feature map to derive appropriate compression data/information for use for the operation in the manner of the technology described herein, if desired. For example, the output feature map could be subjected to the compression process, but without the compressed output feature map then being stored to memory.

It would also be possible, for example, to perform some further processing of metadata (e.g. that is generated anyway) for the output feature map to then provide the metadata that is used to determine/for the property or properties of the output feature map on which the branch selection is based.

The property or properties of the output feature map (e.g. the metadata) is in an embodiment determined as the output feature map is being generated by the layer preceding the branching point, and in particular such that the property or properties (e.g. the metadata) can be and is determined without the need to fetch the output feature map from memory again in order to be able to determine the property (e.g. metadata) for the output feature map. Thus in an embodiment the property or properties (e.g. metadata) is determined as the output feature map is being generated (and e.g., in the case where the output feature map is to be written out to memory, as or before the output feature map is written out to memory). (Such processing could be done, for example, while data (e.g. weights) for a layer is being fetched.)

The determining of the property or properties (e.g. metadata) of the output feature map can be determined by any suitable and desired processor and processing element of the system/processor that is performing the neural network processing, as desired. For example, it may be, and in an embodiment is, performed by the processor that is performing the neural network processing, e.g., and in an embodiment as the output feature map is being generated.

The property or properties can be used to select the branch or branches to use in any suitable and desired manner. For example, and in an embodiment, the property or properties could be compared to one or more threshold values and/or ranges for the property in question, with the branch to use being selected based on whether the value of the property or properties for the output feature map (part) from the layer preceding the branching point is within the appropriate range, e.g. is less than (or less than or equal to), or greater than (or greater than or equal to), a threshold value (range) for the property (with each branch in an embodiment being associated with a respective range or ranges (threshold or thresholds) for the property or properties in question, and the branch associated with the range/threshold for the property or properties in question then being selected accordingly).

The driver could, for example, e.g. at compile time, analyse the neural network and the processing resources that are available in the data processing system, and thereby determine, for example, appropriate parameters and thresholds for triggering the use of particular branching in the neural network, with the branch selection then being made accordingly for any particular neural network processing to be performed.

It would be possible to always use the same property or properties (and, e.g. threshold values for that property or properties) for each branching point in a given neural network. However, in an embodiment, different branching points can (and do) use different properties and/or, e.g. threshold values, for those properties, when making the branch selection.

For example, depending upon the nature and purpose of the output feature map, it may be that different properties and/or different values of the same property, would be more appropriate for selecting the branch to take next. For example, in the case of an “edge detecting” feature map, if such a feature map contains mostly zeros, there are likely to be no edges in the region where the edge detecting feature map value are all mostly zero. In this case, that could be used as an indicator and property on which to base the selection of the branch to take next. On the other hand, for other feature maps, it may be that a different data value (rather than all zeros) would be better to make the branch selection based on (and/or that the selection decision should be different in the case where the values are all mostly zero).

The selection of which branch to use could be based solely on a property or properties of the output feature map from the preceding layer (and in one embodiment that is the case). However, it would also be possible to base the selection on other criteria/conditions as well as a property or properties of the output feature map from the preceding layer, if desired.

Thus, in an embodiment, the technology described herein comprises selecting the branch to use for the neural network processing based on a property or properties of the output feature map from the layer preceding the branch point, and based on one or more further conditions or criteria.

The further criteria and conditions that are considered in this regard can be any suitable and desired criteria and conditions on which the branch selection could be based.

In one embodiment, the further condition or criteria that is used in addition to a property or properties of the output feature map comprises the purpose (the use case) for which the neural network is being used. For example, where the neural network is being used to perform neural network processing for which relatively higher accuracy is desired (e.g. for a safety or security-critical application), then a particular branch may always or more preferentially be selected, e.g. irrespective of the particular property or properties of the output feature map of the preceding layer.

It would also or instead, and in an embodiment also, be possible to consider, for example, the overall power budget (cost), for the neural network processing via the different branches (and the available power in the device that is performing the neural network processing). For example, in a battery powered device, a less power hungry branch could be selected in situations where the remaining battery life is below a threshold.

In the case where different parts (regions) of an output feature map may be sent down different branches, then in an embodiment the decision of whether to send different parts (regions) of the output feature map down different branches (i.e. whether to use plural branches for the subsequent processing) is also based on some measure of the relative cost between processing all of the output feature map down the same, single branch, and processing different parts (regions) of the output feature map down different branches.

This in an embodiment takes account of one or more of, and in an embodiment plural of, and in an embodiment all of: the size of a (and of each) part (region) to go down a respective branch and/or the total size of all the parts (regions) to go down a respective branch; a compute (processing) overhead for processing the plural branches (as compared to a single branch); any processing benefits of using plural branches (compared to a single branch); any memory (e.g. fetch) overhead in using plural branches as compared to a single branch; any memory (e.g. fetch) benefit in using plural branches as opposed to a single branch; any scheduling overhead when using plural branches as compared to a single branch; and any overhead relating to a need to recombine the processing results of different branches at a later time.

In an embodiment, the selection of which branch to use is also based on the available hardware for executing the neural network processing of the branch or branches. This could be based, for example, on whether given hardware/device is busy or not.

As discussed above, it would be possible to configure branches in the neural network that are more optimised for particular forms of hardware (e.g. in terms of their processing resources, memory resources, etc.). In that case, it could be identified what hardware is available for executing the different branches of the neural network, and the branch to use selected, at least in part, based on the hardware that is available for its execution in the system.

In an embodiment, the branches are selected, at least in part, based on the hardware that is available for their execution in the system.

This could, for example, take account of one or more or all of: the processing/compute capability of the available hardware and/or processor(s), the operators (functions) the hardware/processor(s) are able to process, the data types the hardware/processor(s) is configured to handle, and the amount of memory the hardware/processor(s) has available for neural network processing, etc.

This could also consider, for example, the processing resource available and/or the requested processing requirements (e.g. in terms of one or more, or all of: latency, throughput, energy efficiency, etc.), and then select an appropriate processor or processing hardware accordingly.

This could consider, for example, what forms of processor (processing unit) are available for executing the branches of the neural network and selecting the branch to use accordingly, and/or considering what processing hardware (e.g. functional units) an individual processor has available for executing the neural network processing (with the branch to use then being selected accordingly).

For example, where the neural network includes a choice of branches that comprise either (mostly) fully connected layers or (mostly) convolution layers (but intended to perform the same overall processing task), then where a processor that more efficiently supports convolution operations (such as an NPU) is being used or available to execute the neural network, the “convolution” branch could be selected, but where the processor that is being used or is available for use for executing the neural network is more appropriate for executing fully connected layers (such as a GPU), then the “fully connected layer” branch could be selected instead.

It is believed that selecting a branch of a neural network to use based on the hardware resources available for executing the neural network may be new and advantageous in its own right.

Thus, another embodiment of the technology described herein comprises a method of operating a data processing system, the data processing system comprising one or more processors operable to execute neural network processing, and memory for storing data relating to the neural network processing being performed by the one or more processors, the method comprising:

when executing on the one or more processors a neural network comprising:
a sequence of plural layers of neural network processing to process an initial input data set to generate a final output data set that is the result of processing the initial input data set using the neural network;
wherein:
at least one of the layers of the sequence of plural layers of the neural network is followed by two or more branches of neural network processing, each branch comprising a different sequence of one or more layers of neural network processing, whereby the neural network processing from the layer that is followed by two or more branches of neural network processing onwards can be selectively performed via one or more of the different branches of neural network layers:

for a layer of the neural network that is followed by two or more branches of neural network processing, selecting the branch or branches to use for the neural network processing from that layer onwards based on an available processing resource of the one or more processors for performing the neural network processing.

Another embodiment of the technology described herein comprises a data processing system, the data processing system comprising:

one or more processors operable to execute neural network processing;

memory for storing data relating to the neural network processing being performed by the one or more processors; and

a processing circuit configured to:
when the one or more processors is executing a neural network comprising a sequence of plural layers of neural network processing to process an initial input data set to generate a final output data set that is the result of processing the initial input data set using the neural network, and at least one of the layers of the sequence of plural layers of the neural network is followed by two or more branches of neural network processing, each branch comprising a different sequence of one or more layers of neural network processing, such that the neural network processing from the layer that is followed by two or more branches of neural network processing onwards can be selectively performed via one or more of the different branches of neural network layers:

select the branch or branches of neural network processing to use for the neural network processing following a layer of a neural network that is followed by two or more branches of neural network processing, based on an available processing resource of the one or more processors for performing the neural network processing.

As will be appreciated by those skilled in the art, these embodiments of the technology described herein can, and in an embodiment do, include any one or more or all of the features of the technology described herein described herein, as appropriate.

Thus, for example, in one embodiment, there are two (or more) processors available for and that are executing the neural network, such as an NPU and a GPU, each of which has different available processing resources for performing the neural network processing as compared to the other processor, and the selection of the branch or branches to use for the neural network processing from the branch point onwards is based on which of the two processors (e.g. which of the NPU and GPU) is available for performing the neural network processing, and the processing required for each different branch (e.g. whether it is more suited for execution on an NPU or GPU).

Additionally or alternatively, and in an embodiment additionally, the available processing resources of a single processor for performing the neural network processing may be considered, with the branch or branches to use for the neural network processing then being selected based on the available processing resources of that single processor (within a particular processor). Thus in an embodiment, the selection of the branch or branches to use for the neural network processing following the branch point comprises selecting the branch or branches to use for the neural network processing based on available processing resources for performing the neural network processing of a processor that is performing the neural network processing (and the type of processing that the branch or branches require).

Other arrangements would, of course, be possible.

The technology described herein also extends to the generation of a neural network having different branches tailored for execution on different processors/hardware, and to such a neural network per se.

Thus, another embodiment of the technology described herein comprises a method of generating a neural network that can be executed by one or more processors to perform neural network processing, the method comprising:

generating a neural network comprising:
a sequence of plural layers of neural network processing to process an initial input data set to generate a final output data set that is the result of processing the initial input data set using the neural network;
wherein:
at least one of the layers of the sequence of plural layers of the neural network is followed by two or more branches of neural network processing, each branch comprising a different sequence of one or more layers of neural network processing, whereby the neural network processing from the layer that is followed by two or more branches of neural network processing onwards can be selectively performed via one or more of the different branches of neural network layers;
the method further comprising:
for at least one set of two or more branches of neural network processing that follow a layer of the sequence of plural layers of the neural network:
configuring one of the branches of neural network processing for processing on a first type of processing resource; and
configuring another one of the branches of neural network processing for processing on a second, different type of processing resource.

Another embodiment of the technology described herein comprises an executable neural network that can be executed on one or more processors to perform neural network processing, wherein the neural network comprises:
a sequence of plural layers of neural network processing to process an initial input data set to generate a final output data set that is the result of processing the initial input data set using the neural network;
wherein:
at least one of the layers of the sequence of plural layers of the neural network is followed by two or more branches of neural network processing, each branch comprising a different sequence of one or more layers of neural network processing, whereby the neural network processing from the layer that is followed by two or more branches of neural network processing onwards can be selectively performed via one or more of the different branches of neural network layers; and
one of the branches of neural network processing is configured for processing on a first type of processing resource; and another one of the branches of neural network processing is configured for processing on a second, different type of processing resource.

As will be appreciated by those skilled in the art, these embodiments of the technology described herein can, and in an embodiment do, include any one or more or all of the features of the technology described herein described herein, as appropriate.

Thus, for example, and in an embodiment, one of the branches of neural network processing is configured for more optimal processing on a first type of processing resource, and another one of the branches of neural network processing is configured for more optimal processing on a second, different type of processing resource, and the processing resources that the different branches are configured for (are more optimal for) may be different types of processors per se, such as an NPU and a GPU, and/or they could be different (types of) processing resources (hardware/circuits) that may be available within a single processor (within the same processor).

Other arrangements would, of course, be possible.

Once the branch or branches to use for performing the neural network processing following a branching point have been selected, then the selected branch or branches of neural network processing should be executed for the appropriate part or parts or all of the output feature map from the layer that precedes the branching point.

This processing can be triggered and controlled and performed in any suitable and desired manner, such as, and in an embodiment, in accordance with the normal mechanisms for controlling and performing neural network processing in the processor and data processing system in question.

Thus, for example, and in an embodiment, where the processor and/or data processing system includes an appropriate controller, such as a command stream frontend, that controls the performing of neural network processing by the processor, that controller can correspondingly cause the appropriate branch or branches of the neural network processing to be executed. For example, where the neural network processing is performed by executing commands in a command stream that causes the neural network processing, the appropriate commands for the selected branch or branches can be added to the command stream, and then executed in the normal manner for the processor(s) and data processing system in question.

Correspondingly, where different parts of an output feature map are to be processed using different branches of the neural network processing, the respective parts of the output feature map to be subjected to the different branches of the neural network processing can be indicated in any suitable and desired manner (e.g. in the command stream), for example by identifying the “positions” in the output feature map that correspond to the parts of the output feature map in question.

In an embodiment, the control and triggering of the execution of the selected branch or branches of the neural network processing also operates to select the processing resources that a selected branch of the neural network processing to be performed is executed on (where the processor and/or data processing system has available different processing resources that the selected branch or branches could be executed using).

As discussed above, the Applicants have recognised in this regard that different types of neural network processing may be more suited to execution on particular processors/processing circuits. The execution of the selected branches therefore in an embodiment takes account of and advantage of this, where it is possible to do that.

Thus, in an embodiment, the processing resource (e.g. processor or processing resource (circuits) within a given processor) that is used for executing a selected branch of the neural network processing is selected based on the type of processing that the branch performs (e.g., and in an embodiment, as discussed above, whether the branch performs (mostly) convolution operations or comprises (mostly) fully connected layers).

Thus, in an embodiment, the operation in the manner of the technology described herein further comprises (and the data processing system/processor comprises a processing circuit configured to), once a branch of the neural network processing has been selected, selecting a processing resource to use to execute the selected branch of neural network processing based on the type of processing required for the selected branch (and then causing (triggering) the selected branch to be executed using the selected processing resources).

As discussed above, this selection of the processing resources to use for executing a selected branch of the neural network processing could comprise selecting between different processors (e.g. an NPU and a GPU) for executing the selected branch, and/or selecting between different processing resources (processing circuits) of an individual processor for executing the branch.

In these arrangements, the driver, for example, could indicate to the neural network processing execution control, information about the processor/hardware available for neural network processing in the data processing system in question, with the neural network processing control then, where appropriate, selecting the branch or branches to use based on the indicated processor/hardware resources available for performing the neural network processing. Other arrangements would, of course, be possible.

Where different parts of an output feature map are to be processed using different branches following a branch point, then the processing of the different parts of the output feature map by the different branching points is in an embodiment organised and scheduled so as to, for example, reduce or minimise the number of different memory accesses that may be required, so as to make the processing of the different parts via the different branches more efficient. For example, all the parts that are going to go down the same branch could be processed together, followed by processing the other parts down a different branch. Other arrangements would, of course, be possible.

The branch selection could also consider whether a (the) previous input (e.g. the previous frame) used a particular branch or not, and base the selection decision on that as well. For example, it could be determined whether a given part of the current output feature map from the layer preceding the branching point is sufficiently similar to that part of the feature map for a preceding input, and if so, the branch that was used previously could (preferentially) be selected.

As discussed above, one or more of the branches following a branching point may themselves include another branching point or branching points. Thus the execution of a branch of the neural network processing may comprise encountering a further branching point or points, and making a further branch selection(s) at that point (and so on). This may be particularly applicable for the main or primary branch of the neural network processing (which may, for example, include plural branching points).

The results of the processing of the selected branch or branches of neural network processing can be used in any suitable and desired manner, e.g., and in an embodiment, depending on the nature of the neural network processing that is executed by the branch and/or that is required for the processing for the remainder of the neural network being executed.

For example, where different parts of an output feature map are sent down different branches, and there is no requirement for any later processing in the neural network to have the results of the processing of the entire output feature map prior to the branching point (e.g. where the remainder of the neural network comprises convolution layers and no fully connected layers (for example where segmentation or enhancement is being performed)), then it would be possible to process the different parts of the output feature map that have gone down different branches all the way to the ends of their respective branches, without any need to “recombine” the results of the processing via the different branches.

On the other hand, where later processing in the neural network requires the results from the entirety of the output feature map from the layer prior to the branching point (e.g. where there are fully connected layers later in the neural network performing fully connected layer processing that will need the entire output feature map from before the branching point in order to proceed), then the processing is in an embodiment so as to allow the results from the entirety of the output feature map from the layer prior to the branching point to be available to those later, e.g. fully connected, layers.

To achieve this, the branch decision could, for example, be configured to send to the entire feature map from the layer prior to the branching point down the same, single branch (so that the processing of that entire output feature map will be available to any later, e.g. fully connected, layer in that manner) (and in one embodiment that is what is done).

Alternatively, different parts of the output feature map could still be sent down different branches, with the later neural network execution being configured to reassemble the results of that processing into an appropriate input feature map for input to any later, e.g. fully connected, layer that needs the entirety of the results from the entirety of the output feature map from the layer prior to the branching point (i.e. such that the entire feature map can be and is reassembled downstream of the branching point for input to any layer that requires the entire feature map (such as a fully connected layer)).

Thus, in an embodiment, the technology described herein comprises combining the results of processing different parts of an output feature map using different branches of neural network processing to provide a “combined” feature map for input to a later layer of the neural network processing (where that is required).

The “recombination” (reassembly) of a feature map from different parts of the feature map that have been processed via different branches can be done in any suitable and desired manner, for example by storing the different parts of the feature map in an appropriately “reassembled” form in memory.

In an embodiment, the result of processing (part of) an output feature map via a particular branch is checked to determine if that processing was “successful” (e.g. and in an embodiment based on a measure of the accuracy of the processing by the branch, for example in terms of a confidence value for the result of that processing), and in the event that the processing via the particular branch is determined not to be “successful” (e.g. the confidence value for the processing via that branch is too low (is below a threshold confidence value), then the processing of the part of the output feature map that was processed using the particular branch is in an embodiment repeated using another one of the branches of the neural network processing available at the branching point in question.

This will then provide a “sense check” on whether it was appropriate to process the part of the output feature map using the initially selected branch of neural network processing.

This may particularly be used and useful where, for example, a secondary, “simpler” branch of neural network processing is selected for part of an output feature map, to determine whether that secondary branch can, e.g., identify anything in the output feature map part with a sufficiently high probability, with the part of the output feature map then being retried using the primary, more complex, branch when it is determined that the processing via the secondary, simpler branch was not sufficiently reliable/accurate.

Thus in an embodiment, the method of the technology described herein comprises (and the processing circuit/processor is correspondingly configured to) assessing the result of the processing of (part of) an output feature map using one of the branches at a branching point, and determining whether to re-process the (part of) the output feature map using a different one of the available branches at the branching point based on the assessment (and where it is determined to re-process (part of) the output feature map using a different branch, processing the (part of) the output feature map using the different branch of neural network processing).

Where there are more than two branches at a given branching point, this process could, if desired, be repeated for each of the branches, e.g. in turn, until a branch provides an acceptable “result”.

It would also be possible, for example, to periodically disable the branching operation and simply execute the “full” neural network processing for a given input, and then compare the result of that “full” processing with the result obtained for the same or other inputs using the branching configuration, to determine whether the branching operation is providing suitable (e.g. sufficiently accurate) results or not. For example, when processing frames of video using a neural network, the results of previous and current frames could be compared for accuracy, and/or the same frame could be processed solely using the “full” network and using the “branching” network and the results compared. Other arrangements would, of course, be possible.

The neural network that is being executed in the technology described herein can be generated and configured in any suitable and desired manner.

Thus, the neural network may be trained using any suitable set of training data, e.g. based on the neural network processing task in question. The training itself can be performed as desired, e.g. in a known fashion. In an embodiment this is performed in a supervised manner using appropriate training data including appropriate input/output features depending on the neural network processing task in question.

The training is typically (in an embodiment) performed in advance, and “offline”, and can be performed on any suitable processor.

It will be appreciated that the execution of the neural network processing may therefore generally, and typically, take place sometime after the initial neural network generation, and typically at a different place (on a different processor). For example, the executable neural network will normally (and in an embodiment) be generated offline and then provided to a data processing system for use as and when desired. A host processor (e.g. CPU) of the data processing system when executing an application that requires neural network processing can then trigger the desired execution of the neural network.

Thus, in an embodiment the neural network processing is performed under the control of a host processor (CPU), as and when required by an application executing on the host processor. Thus, the host processor may issue commands to cause the neural network processing to be performed. The neural network processing may then be performed using appropriate processors/hardware of the data processing system.

The (overall) data processing system in which the neural network is being executed may comprise any desired components and elements that a data processing system can comprise, such as one or more or all of: a display processing unit (display processor), a central processing unit (CPU), a graphics processing unit (GPU) (graphics processor), a video processor, a digital signal processor, one or more neural network processors, a display and a memory.

The processors may be arranged within a system-on-chip system.

The memory of the data processing system may comprise memory for storing data, inter alia, relating to neural network processing. For example, the memory may store data for input data arrays, output data arrays, and weight data arrays. The memory may comprise one or more local memories, which may be located on-chip. The local memory may comprise one or more caches.

The memory may also comprise a main memory, which may be an external memory which may be located off-chip. The main (external) memory may be any suitable type of memory, such as SDRAM for example.

The data processing system (and in particular the processors of the data processing system) may be operable to access data which is present in a local memory (cache) when performing neural network processing. The data processing system may be operable to request data to be transferred from main (external) memory to local memory if data that is required is not already present in the local memory. The data processing system may comprise one or more circuits for transferring data from main memory to local memory (and for transferring data from local memory to main memory), e.g. such as one or more a direct memory access (DMA) units which may be associated with the processor which is to perform the neural network processing.

The data processing system may comprise and/or be in communication with one or more memories (such as the memories described above) that store the data described herein, and/or store software for performing the processes described herein. The data processing system may comprise and/or be in communication with a host microprocessor, and/or with a display for displaying output data associated with the neural network processing.

The data processing system of the technology described herein may be implemented as part of any suitable system, such as a suitably configured micro-processor based system. In some embodiments, the technology described herein is implemented in a computer and/or micro-processor based system.

The various functions of the technology described herein may be carried out in any desired and suitable manner. For example, the functions of the technology described herein may be implemented in hardware or software, as desired. Thus, for example, the various functional elements of the technology described herein may comprise a suitable processor or processors, controller or controllers, functional units, circuits, processing logic, microprocessor arrangements, etc., that are operable to perform the various functions, etc., such as appropriately dedicated hardware elements (processing circuits) and/or programmable hardware elements (processing circuits) that can be programmed to operate in the desired manner.

It should also be noted here that, as will be appreciated by those skilled in the art, the various functions, etc., of the technology described herein may be duplicated and/or carried out in parallel on a given processor. Equally, the various processing circuits may share processing circuits, etc., if desired.

It will also be appreciated by those skilled in the art that all of the described embodiments of the technology described herein may include, as appropriate, any one or more or all of the features described herein.

The methods in accordance with the technology described herein may be implemented at least partially using software e.g. computer programs. It will thus be seen that when viewed from further embodiments the technology described herein comprises computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system.

The technology described herein also extends to a computer software carrier comprising such software which when used to operate a data processing system causes in a processor, or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein comprises computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

The present embodiments relate to neural network processing.

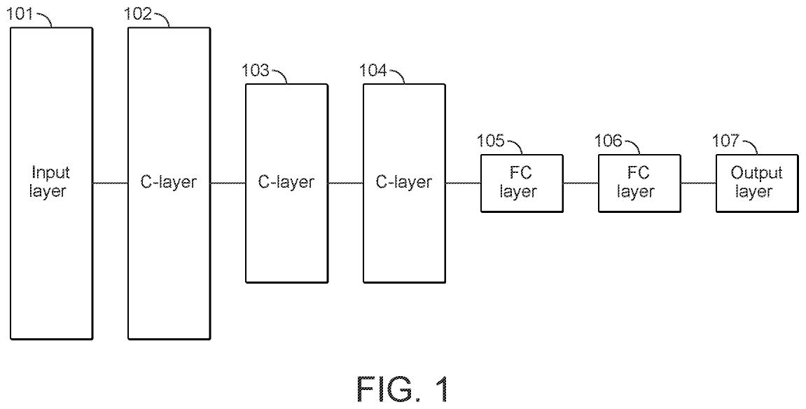

Neural network processing typically comprises a sequence of “layers” of processing, such that the output from each layer is used as an input to a next layer of processing. FIG. 1 shows an exemplary sequence of layers of neural network processing from an initial input layer 101 to a final output layer 107, between which are layers comprising various convolutional layers (C-layers) 102, 103, 104, and fully-connected layers (FC layers) 105, 106.

The input layer 101 may be configured to receive input data (e.g. image or sound data), and to provide that input data in a suitable form (e.g. as an array of data elements, otherwise known as a “feature map”) for use by subsequent neural network layers. The feature map will generally comprise a three-dimensional array of data elements, each data element having data associated therewith. The feature map may have a width (W), a height (H) and a depth (C), wherein the width (W) and height (H) may be defined as the number of data elements in the width and height direction respectively, and the depth (C) may correspond to a number of data channels. For example, in the case of input data comprising an image, the width and height of the array provided by the input layer may correspond to a number of data positions (e.g. pixels) along the width and height direction of the image respectively, whilst the channels may comprise the RGB channels of the image.

After the input layer, there may be one or more other layers of neural network processing (e.g. including convolutional layers, fully-connected layers, pooling layers, deconvolution layers, or any other layers of neural network processing that may be present).

Generally, a layer of neural network processing will process an input feature map (IFM) in order to generate a corresponding output feature map (OFM) (e.g. in the case of a convolutional layer, deconvolution layer, or pooling layer), or output value (e.g. a probability in the case of a fully-connected layer). The output generated by a layer of neural network processing may be used as the input for a next layer of neural network processing in the sequence, and so on.

The operation performed by each layer of neural network processing may comprise any suitable operation which manipulates an input (feature map) to provide an output (feature map). The operation may require process parameters (e.g. such as weights for a filter or “kernel”) which may be specific to a particular layer of neural network processing. Hence, suitable process parameters (e.g. weights and biases) may be read from working memory (e.g. a buffer) in order to perform each layer of neural network processing.

With reference to FIG. 1, the final layer of neural network processing in the sequence may comprise an output layer 107. The output layer may process an input feature map to generate useful output data (e.g. an inference or classification result, or an output image in the case of image processing, etc.).

Typically, data corresponding to an output feature map generated by a layer of neural network processing may be written to a suitable working memory (e.g. a buffer). A next layer of neural network processing may then read that data from the buffer for use as an input feature map for the next layer of neural network processing.

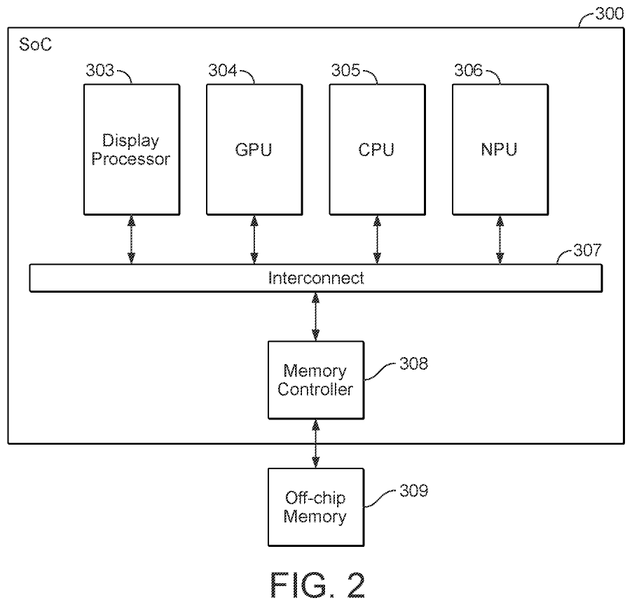

FIG. 2 shows an exemplary system on-chip (SoC) data processing system 300 within which the present embodiments can be employed. As shown in FIG. 2, the data processing system 300 in the present embodiments comprises a host processor in the form of a central processing unit (CPU) 305, a graphics processor (GPU) 304, a display processor 303, a neural processing unit (NPU) 306 and a memory controller 308. As shown in FIG. 2, these units communicate via an interconnect 307 and have access to off-chip memory 309.

In this system, the graphics processor 304 will (when performing graphics processing) render frames (images) to be displayed, and the display processor 303 will then provide the frames for output, e.g. to a display panel for display.

The neural processing unit (NPU) 306 will perform neural network processing. The neural processing unit (NPU) 306 comprises circuits (hardware) (e.g. such as multiply-accumulate circuits 110) which are specifically configured to most efficiently perform neural network processing in a particular predetermined manner. The neural processing unit (NPU) 306 is thus designed to perform certain types of neural network processing operations in an optimised manner.

In the present embodiments, it is assumed that as well as the neural processing unit (NPU) 306, being able to perform neural network processing, both the GPU 304 and the CPU 305 can be (selectively) used and controlled to perform neural network processing, i.e. such that for a given neural network being executed, the neural network processing can be, if desired, distributed between two or more of the NPU 306, GPU 304 and CPU 305. This will be discussed in more detail below.

The data processing system 300 may of course include any other components or processing units that may be desired. For instance, the data processing system 300 may further comprise an image signal processor (ISP), a video decoder, an audio codec, etc., or any other components that a data processing system 300 may desirably have. A sensor may provide input data for the system 300 (e.g. video data and/or sound data from a suitable camera or microphone or other sensor device).

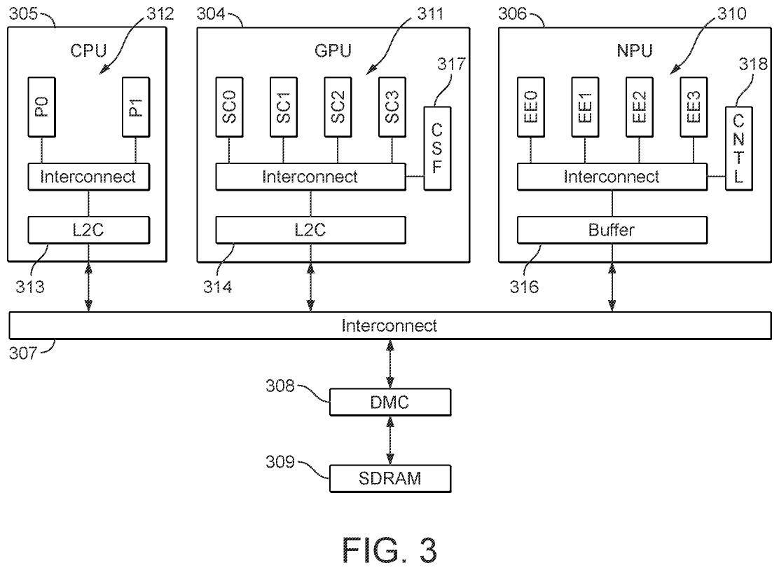

FIG. 3 shows elements of the CPU 305, GPU 304 and NPU 306 that are relevant to the execution of neural networks in the embodiments of the technology described herein in more detail.

In particular, as shown in FIG. 3, each of the CPU 305, GPU 304, and NPU 306 include multiple execution units that may be used for neural network processing. Thus the NPU 306 includes four execution engines 310, the GPU 304 includes four shader cores 311, and the CPU 305 includes two processing cores 312 that may each be used to perform neural network processing.

As shown in FIG. 3, each of the processing units also has appropriate local storage, in the form of level 2 caches 313 and 314 for the CPU 305 and GPU 304, and a buffer 316 for the NPU 306.

The GPU 304 also includes an appropriate controller 317, e.g. in the form of a command stream frontend or job manager, that is operable to control and distribute work, such as processing tasks, to the shader cores 311. The NPU 306 correspondingly includes an appropriate controller 318 that is operable to control and distribute work (processing tasks) to the execution engines 310. One or both of the processing cores 312 of the CPU 305 may correspondingly be able to determine and distribute work (processing tasks) to the processing cores 312 of the CPU. Each of the command stream frontend (e.g.) 317, controller 318 and processing core 312 (when acting as a controller) may, for example, be an appropriate processor, such as a CPU, which executes programs to control and distribute work to the appropriate execution units/cores of the processor in question.

(It will be appreciated that there will be other elements and components, etc., of the respective processors and data processing system that are not shown in FIGS. 2 and 3. FIGS. 2 and 3 simply show the components and elements of the system and processors that are particularly relevant to the operation in the manner of the present embodiments.)

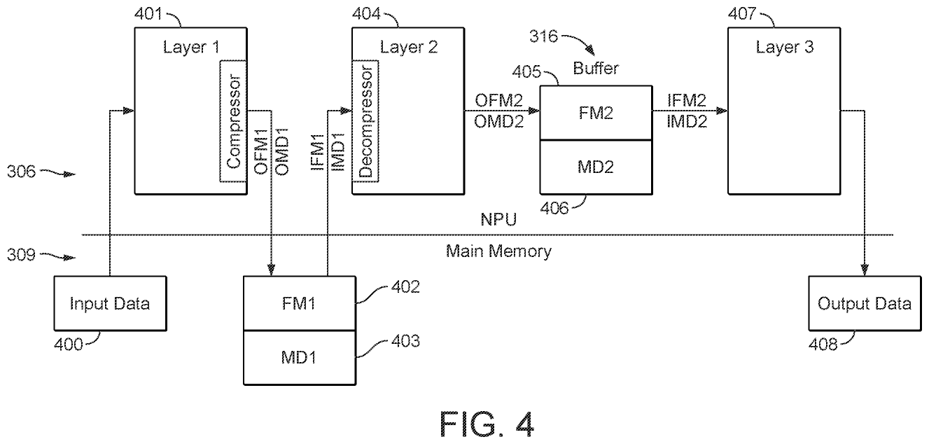

FIG. 4 shows schematically how the data may be handled (fetched, processed and generated) for a number of layers of neural network processing in the present embodiments, for example when the NPU 306 is processing a sequence of layers.

As shown in FIG. 4, when processing a sequence of layers, the initial input data 400 will be loaded from the main memory 309 and processed as a first layer 401 of neural network processing on the NPU 306. In this example it is assumed that the output feature map OFM1 from the first layer of processing is too large to be stored in the NPU's on-chip buffer 316, and so that layer is compressed and written out to the main memory in compressed form 402, together with an appropriate set of compression metadata 403.

For the next layer of processing, the compressed output feature map from the first layer 402 is fetched and decompressed and subject to a second layer of neural network processing 404 on the NPU 306. In this case it is assumed that the output of the second layer of processing 404 will fit within the local storage buffer 316 of the NPU 306, and so the output feature map from the second layer (OFM2) is stored in the buffer in an uncompressed form 405. In this case, metadata 406 providing information about the output feature 405 is also generated and stored.

The output feature map 405 from the layer 2 processing is then subject to a third layer of processing 407, with the result of that processing then being written out to the main memory 309 as output data 408.

Other arrangements (such as there being a longer sequence of layers of neural network processing) would, of course, be possible.

The technology described herein relates in particular to the execution of neural networks that include one or more branching points at which the neural network processing to be performed next can be selectively performed using one or more of the available branches.

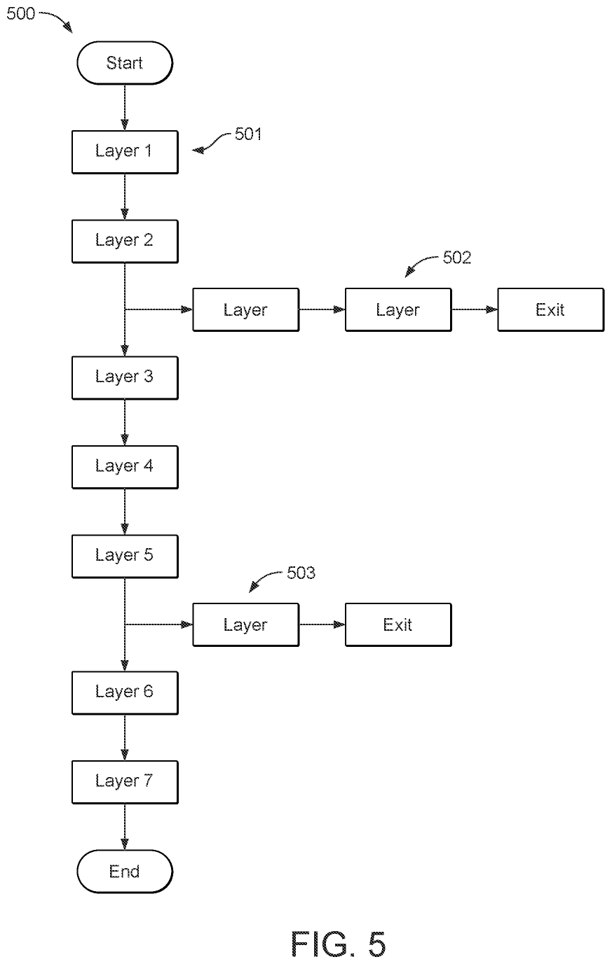

FIG. 5 shows an exemplary neural network that includes a number of branching points at which different branches that can be selected for neural network processing in accordance with the present embodiments.

As shown in FIG. 5, the overall neural network 500 includes a main branch or sequence of layers 501 of neural network processing, comprising layers 1-7 of neural network processing.

However, after layer 2 of the main branch 501 of the neural network processing there is a first secondary or exit branch 502 that can be selected for processing some or all of the output feature map from layer 2 (with any remaining part of output feature map that is not selected for the exit branch 502 still being processed by the main branch (and thus passing to layer 3 of the main branch)). Correspondingly, there is a second secondary “exit” branch 503 following layer 5 of the main, primary branch 501, again at which it can be selected to send some or all of the output feature map from layer 5 via the exit branch 502, rather than via the main branch 501.

Other arrangements, such as there being more branching points in the main branch, and/or one or more of the secondary, “exit” branches themselves including further branches and branching points, would, of course, be possible.

In the present embodiments, it is assumed that the main branch 501 performs more complex and more processing resource intensive neural network processing that, for example, may perform a required neural network processing task to a higher degree of accuracy and/or confidence. Correspondingly, the secondary, exit branches 502, 503, are configured to perform less complex neural network processing, and to correspondingly require less processing resources for their performance.

More particularly, in the present embodiments, the main and secondary branches perform the same overall processing operation (e.g. to identify a particular type of object in an image), but the secondary branches 502, 503 are less resource intensive branches than the main branch 501, and can therefore provide, and are configured to provide, an “early exit” (termination) from the neural network processing for data that is sent down that branch. This may then be used to provide an “early exit” branch from the neural network processing where some or all of the output feature map from the layer preceding the branch point can be identified as being suitable for processing in a less complex manner (e.g., and in an embodiment, because it may be able to be identified that there is unlikely to be anything of interest in a region or regions of the output feature map, or in the output feature map as a whole).

The main and secondary branches accordingly each comprise a different sequence of one or more neural network layers to the other branch or branches at the branch point in question.

The main and secondary branches of neural network processing can differ from each other in any suitable and desired manner, such as in terms of one or more of: the number of layers of neural network processing that are required for each branch; the type(s) of layers of neural network processing that they include; the resources that they require to process; the feature map size and/or the number of feature maps for a layer or layers in the branches; the kernel size or sizes for the layers; whether they include depth-wise separable layers; the level of striding or downsampling used for the layers; the resolution of the data values to be processed for the layers (e.g. 8 vs 16 bit); or any other properties of the layers of neural network processing that may, for example, result in computationally less expensive processing (albeit potentially at the cost of accuracy).

In the present embodiments, when a branch point is reached (after layer 2 and layer 5 in the example neural network shown in FIG. 5), it is decided for respective regions of the output feature map from the layer preceding the branch point whether to process those regions using the main, more complex branch of neural network processing, or the simpler, secondary, exit branch of neural network processing. This decision is made, inter alia, based on a property or properties of the region of the output feature map being considered.

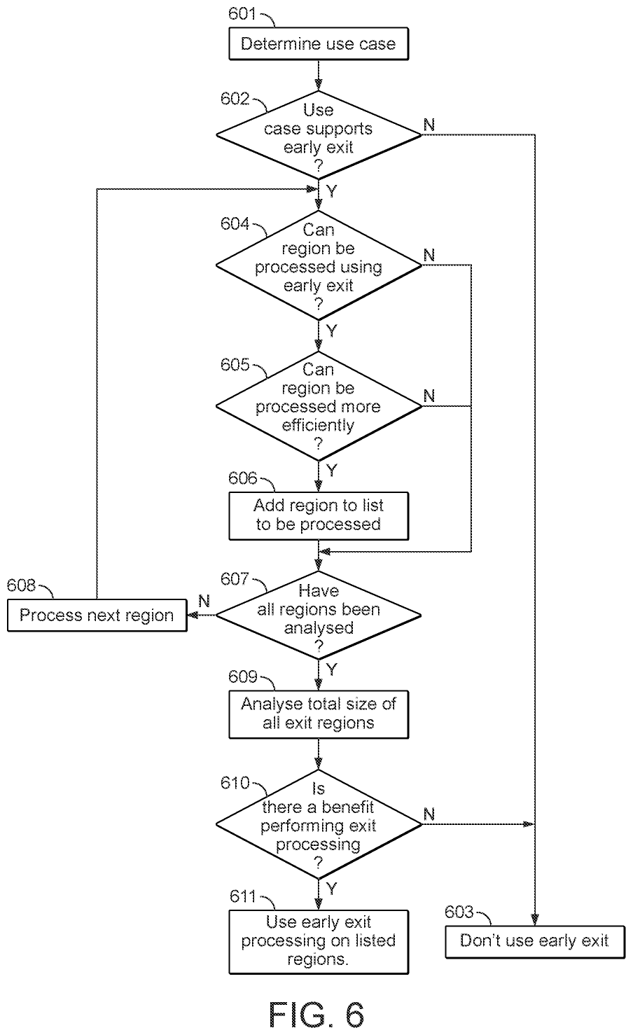

FIG. 6 is a flowchart showing this operation in an embodiment of the technology described herein. FIG. 6 shows the operation in respect of a particular branch point in the neural network. It will be appreciated that this operation would be performed at each branch point that is present in the neural network, as appropriate.

As shown in FIG. 6, it may, if desired, first be determined whether the particular use case (context) for the neural network processing being performed supports the use of “early exit” branches or not (steps 601 and 602).

The Applicants have recognised in this regard that there may be certain use cases, such as for safety critical applications, where it would be desirable to always use the main, more complex processing for the neural network, irrespective of any properties of an output feature map at a branch point. This initial determination therefore allows the possibility of “disabling” the “early exit” branches if desired. When it is determined that the early exit branches should not be used, then the neural network processing will simply proceed down the main branch only (step 603).

On the other hand, where the use of the early exit branches (where possible and desirable) is permitted/enabled, it is then considered for a first region of the output feature map of the layer of processing preceding the branching point whether that region can be processed using the “early exit” branch (step 604).

In the present embodiments, this determination is based on a property or properties of the region of the output feature map from the layer preceding the branch point, and more particularly on a measure of the variability of the data values of in the region of the output feature map (on a measure of the overall information entropy of the region of the output feature map for which the branch selection is being made).

This is then used as an indicator of whether that output feature map region should be subjected to more or less complex processing going forwards (the main or secondary branch processing) (whether the next stage of the neural network processing to obtain the desired result of that stage of the neural network processing may require more or less complex neural network processing to achieve a sufficiently high level of accuracy/reliability).

In the present embodiments, the relative compressibility (or otherwise) of the output feature region, such as the compressed data size (the size of the output feature map data after compression) and/or the compression ratio, of the output feature map region, is used as the measure of the variability/entropy in the output feature map region on which the selection of the branch to take is based. In the present embodiments, this is determined from compression metadata for the output feature map or output feature map region on which the selection of the branch to take is based. Thus if there is a branch point, the compression metadata from the output feature map from the preceding layer is fetched and analysed (either for the entire frame and/or on a region-by-region basis) and used to determine the branch selection. Other arrangements would, of course, be possible.

Then the secondary, exit branch is taken for output feature map regions that are determined to be more compressible, with the main primary branch being selected for output feature map regions that are relatively less compressible.

Other properties of a region of the output feature map, as well as or instead of a measure of the relative compressibility, could be used for the branch selection if desired. For example, one or more of: an indication of whether all or part of the output feature map is all zeros and/or all has the same value; (an indication of) the distribution of the data values in the output feature map region, such as an indication of the range of values in a region of the output feature map; a measure of the number of zeros (or other particular data value) in, or a histogram of the data values for, the (region of the) output feature map; and/or whether the feature map contains values above a particular, in an embodiment selected, in an embodiment predetermined, threshold value, could be generated and used as a property or properties on which to base the branch selection.

The property or properties of the output feature map can be determined and assessed in any suitable and desired manner. In an embodiment, the property or properties is determined and assessed from, e.g. compression, metadata relating to the output feature map (and that is indicative of the property or properties in question).

The property or properties can be used to select the branch or branches to use in any suitable and desired manner. For example, the property or properties could be compared to one or more threshold values and/or ranges for the property in question, with the branch to use then being selected accordingly.

The driver could, for example, e.g. at compile time, analyse the neural network and the processing resources that are available in the data processing system, and thereby determine, for example, appropriate parameters and thresholds for triggering the use of particular branches in the neural network, with the branch selection then being made accordingly for any particular neural network processing to be performed.

When it is determined that the region of the output feature map being considered can be processed using the early exit branch, it is then determined whether processing the region using the early exit branch rather than the main branch would be more efficient (step 605).

This may consider, for example, some measure of the relative cost between processing the output feature map region down the early, exit branch, and the main branch. This may take account of, for example, one or more of: the size of the region; a compute (processing) overhead for processing the region down the exit branch; any processing benefits to processing the region down the exit branch; any memory (e.g. fetch) overhead to processing the region down the exit branch; any memory (e.g. fetch) benefit to processing the region down the exit branch; any scheduling overhead to processing the region down the exit branch; and any overhead relating to a need to recombine the processing results of different branches at a later time.

When it is determined that a region can be processed more efficiently using the early exit branch at the branch point in question, then the region is added to a set of regions to be processed using the early exit branch (step 606).

As shown in FIG. 6, this is done for all regions of the output feature map from the layer preceding the branch point (steps 607 and 608).

Once all the regions have been processed, there will accordingly be a list of regions to be processed using the exit branch. There is then, as shown in FIG. 6, a further determination as to whether using the exit branch for those regions would be beneficial. This comprises, as shown in FIG. 6, determining the total size of all the regions to be processed using the exit branch and then determining whether there is a benefit to performing the exit branch processing for those regions (steps 609 and 610).

This may, for example, be based on some measure of the relative cost between processing all of the output feature map down the main branch, and processing the selected regions of the output feature map down the exit branch. This may takes account of, for example, one or more of: the size of a (and of each) part (region) to go down a the exit branch and/or the total size of all the parts (regions) to go down the exit branch; a compute (processing) overhead for processing the regions down the exit branch; any processing benefits to processing the regions down the exit branch; any memory (e.g. fetch) overhead to processing the regions down the exit branch; any memory (e.g. fetch) benefit to processing the regions down the exit branch; any scheduling overhead when processing the regions down the exit branch; and any overhead relating to a need to recombine the processing results of different branches at a later time.

When it is determined that it would be beneficial to use the exit branch for the identified regions, then those regions are processed via the exit branch (and not via the main branch) of the neural network processing (step 611).

On the other hand, when it is determined that there would not be a benefit to processing the regions using the exit branch, then the entirety of the output feature map is simply processed using the main branch (step 603).

In the present embodiments, the determination and selection of whether and which branch of the neural network to take, and the corresponding control and triggering of the execution of the selected branch or branches, is performed by and under the control of the appropriate controller, such as the command stream frontend/job manager, of the processor or processors in question.

Thus, for example, in the case where the neural network is being executed on the NPU 306 only, the relevant neural network processing tasks will be scheduled and distributed to the execution engines 310 by the controller 318 (which, as discussed above, may be a CPU which executes appropriate programs to perform the control and work distribution).

In this case, as the output feature map is being generated for a layer preceding a branching point, then the output feature map will be appropriately analysed (e.g. in the execution engine that is generating the output feature map), and metadata providing information on regions of the output feature map (e.g. compression metadata) generated and stored in appropriate data structures. The controller 318 when it is to submit tasks to the execution engines to process a next layer after the branching point may then examine the metadata (in the data structures) and schedule tasks to the NPU execution engines 310 accordingly.

Correspondingly, when all the neural network processing is being performed by the GPU 304 only, the relevant neural network processing tasks will be scheduled and distributed to the shader cores 311 by the command stream frontend/job manager 317 (which, as discussed above, may be a CPU which executes appropriate programs to perform the control and work distribution).

In this case, as the output feature map is being generated for a layer preceding a branching point, then the output feature map will be appropriately analysed (e.g. in the shader core that is generating the output feature map), and metadata providing information on regions of the output feature map (e.g. compression metadata) generated and stored in appropriate data structures. The command stream front end/job manager 317 when it is to submit tasks to the shader cores to process a next layer after the branching point may then examine the metadata (in the data structures) and schedule tasks to the GPU shader cores 311 accordingly.

It would also, alternatively or additionally, be possible for one or more of the shader cores 311 to, for example, execute programs to generate data structures based on metadata for an output feature map, which generated data structures could then be read by the command stream frontend/job manager 317 to make the branch selection and schedule tasks based on the branch selection to the shader cores as appropriate.

In the case where the neural network processing is being performed on the CPU 305 only, then a CPU processing core may control the task scheduling distribution, and a CPU processing core will execute the neural network processing. There may be a single or multiple CPU cores in this regard, and if there are multiple CPU cores, the CPUs may have different performance levels (e.g. lower performance and higher performance CPUs).

Again, in this case, as the output feature map is being generated for a layer preceding a branching point, then the output feature map will be appropriately analysed (e.g. in the processing core that is generating the output feature map), and metadata providing information on regions of the output feature map (e.g. compression metadata) generated and stored in appropriate data structures. The “controller” CPU core when it is to submit tasks to the processing cores to process a next layer after the branching point may then examine the metadata (in the data structures) and schedule tasks to the CPU processing cores 312 accordingly.

In the case where there are multiple processors performing the neural network processing (i.e. at least two of the CPU 305, GPU 304 and NPU 306 are being used to perform the neural network processing) then the generated metadata for an output feature map from the (potentially different) processors could, for example, be interpreted by the CPU 305, with the CPU then scheduling and distributing neural network processing tasks as appropriate to the CPU 305, NPU 306 and GPU 304, as required. In this case, in addition to using the metadata and information about the layer to execute, the CPU may also receive and use information on how busy each different processor currently is and is likely to be, to help determine and select the task allocation.

Additionally or alternatively, the generated metadata from the (potentially different) processors could be interpreted by all the different processors (i.e. the CPU, NPU and GPU), but with each processor executing a scheduling algorithm that should generate the same scheduling and work distribution decisions (i.e. such that if the CPU determines that a region should be executed on the GPU, the GPU would make the same determination, and so would the NPU). Each different processor would therefore make (the same) scheduling and distribution determination, and then schedule the tasks that it has determined should be performed by itself on to its processing cores as appropriate. Again, each processor may also receive information on how busy each different processor currently is and is likely to be, to help determine the task allocation, in addition to using the metadata and information about the layer to execute.

Other arrangements would, of course, be possible.

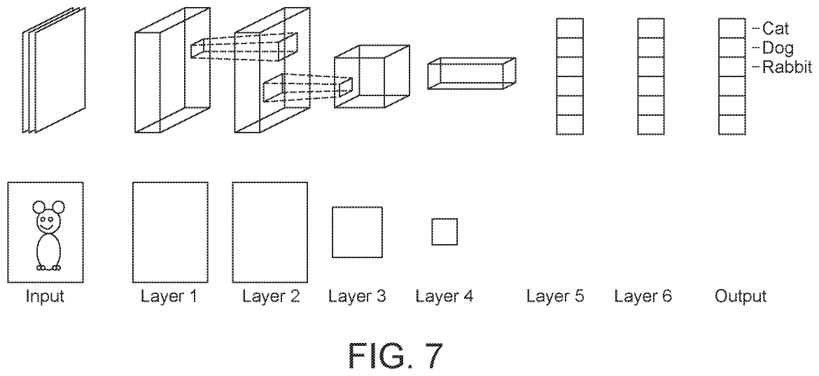

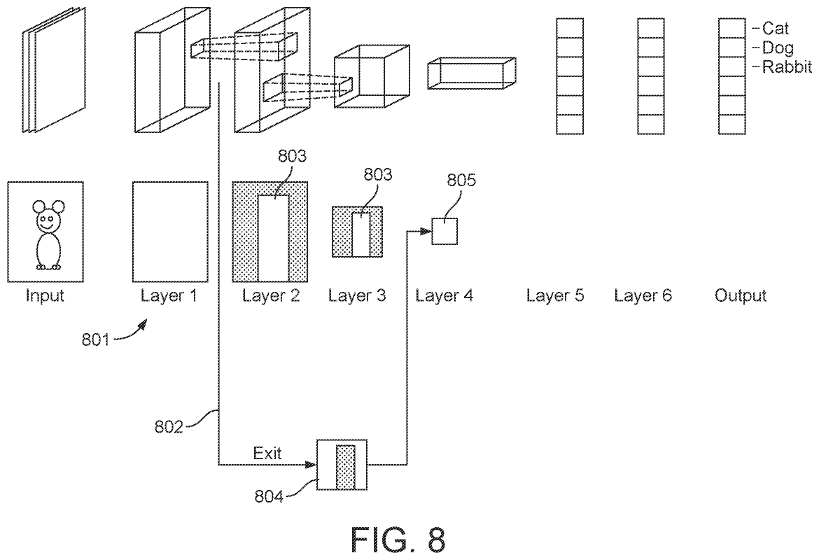

FIGS. 7 and 8 illustrate the use of an exit branch in a convolutional network with a fully connected layer (e.g. that may be used for image classification).

FIG. 7 shows a convolutional network with a fully connected layer without any early exit branch.

FIG. 8 shows the corresponding convolutional network with a fully connected layer but comprising a single exit branch 802 after the first layer (layer 1) 801 of neural network processing.

In this case, as shown in FIG. 8, the region 803 of the output feature map from layer 1 is processed by the main branch of the neural network processing (thus through layers 2 and 3 of the neural network processing), whereas the “outer” region 804 of the output feature map from the layer 1 processing is instead processed via the exit branch 802. The results of the two branches of processing are then recombined 805 for processing by layer 4 onwards of the main branch of the neural network.

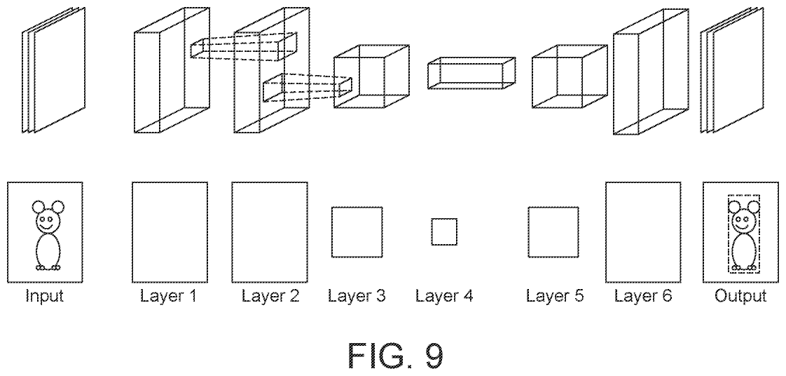

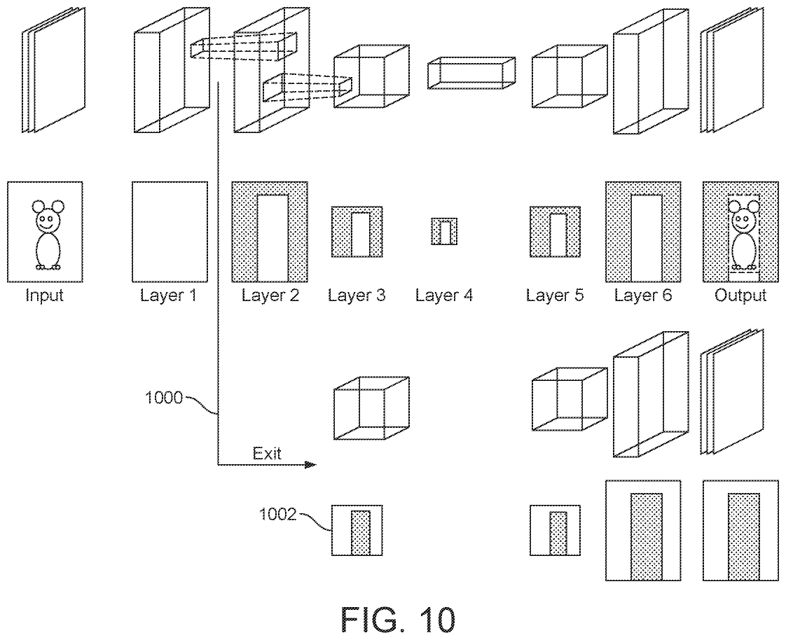

FIGS. 9 and 10 correspondingly show an exemplary convolutional network but without a fully connected layer (and with a deconvolution layer) (e.g. that may be used for image segmentation, or super resolution image enhancement). FIG. 9 shows the network without an early exit branch, and FIG. 10 shows the network with an early exit branch 1000 after the first layer of neural network processing.

Again, in this case, a central region 1001 is processed by the main branch of the neural network, with an outer region 1002 being processed by the early exit branch of the neural network. In this case, as shown in FIG. 10, both sets of regions are processed through their respective branches to the end of the neural network processing (rather than being recombined for processing by later layers of the main branch).

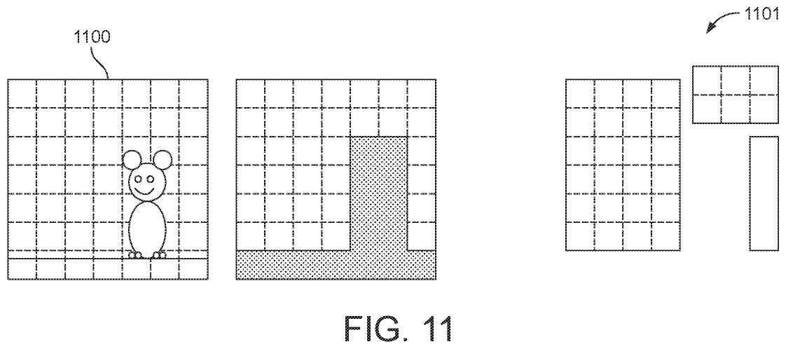

FIG. 11 shows a further example of an output feature map 1100 from a layer preceding a branching point for which, in this example, three regions 1101 are extracted and identified for processing by an early exit branch of the neural network.

Other arrangements would, of course, be possible.

In the present embodiments, and as discussed above in particular in relation to FIGS. 2 and 3, processing for a given neural network being executed can be distributed between the CPU 305 and GPU 304, as well as the NPU 306. Thus in the embodiments of the technology described herein, as well as determining whether to process some or all of an output feature map via an “early exit” branch at a branching point, it is also determined and selected how to distribute the overall processing for the neural network between and across the CPU, GPU and NPU that can be used for that processing.

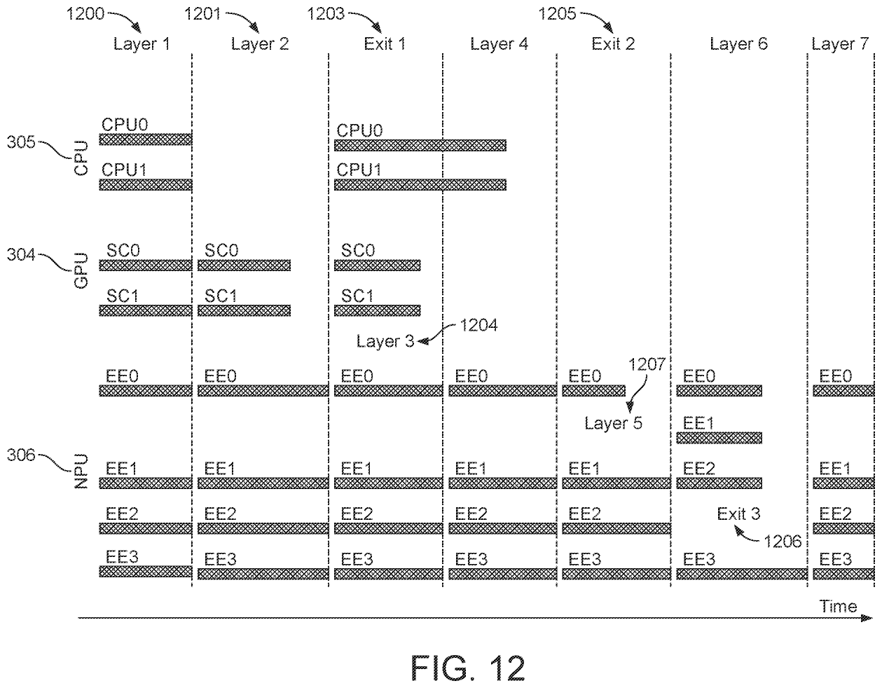

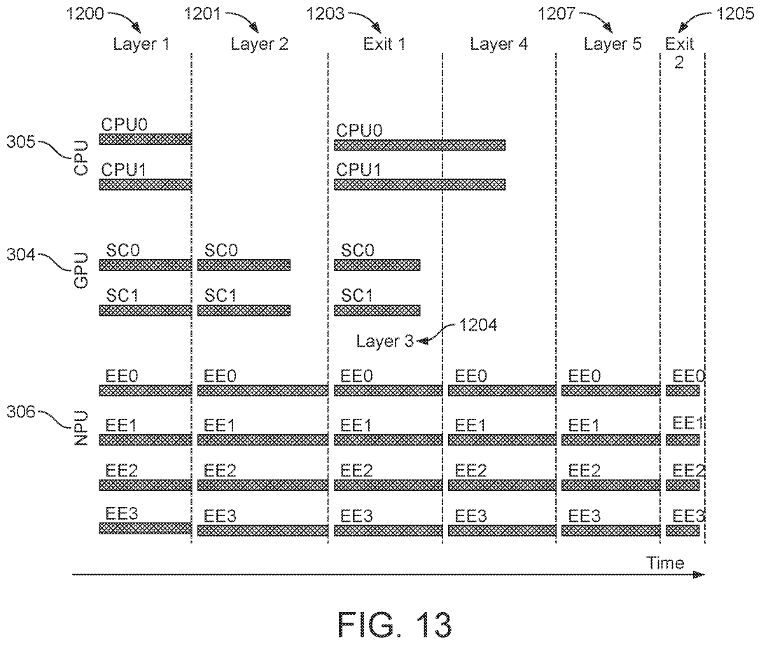

FIGS. 12 and 13 illustrate this.

In the example shown in FIG. 12, it is assumed that there is a main branch of the neural network comprising seven layers, with three potential exit branches. In the example shown in FIG. 12, the first layer of the main branch 1200 is processed on all the processors, and it is assumed that they all take the same amount of time to process the data. Then, for the second layer 1201, only the GPU 304 and NPU 306 are used to process that layer. (In this case it is assumed that the GPU 304 finishes its tasks early, and so may sit idle for some time.)

The second layer is followed by a first exit layer, and as shown in FIG. 12, it is decided that some of the output from layer 2 will be processed via the exit layer 1203, with other regions of the output being processed by layer 3 1204 of the main branch of the neural network.

In this case, as shown in FIG. 12, it is assumed that the exit branch is processed using the CPU 305 and GPU 304, with the main branch layer 3 processing being performed by the NPU 306. This may be appropriate, as the input feature map data being fetched for processing for these layers will likely be used for both layer 3 of the main branch and the first exit branch processing. FIG. 12 shows schematically an example where the exit branch processing may take some time on the CPU, but that would be acceptable as the CPU 305 may not be being used immediately for other processing.

Layer 4 of the main branch of the network is then processed as normal on the NPU 306 (using the output of layer 3 of the main branch processing).

There is then a second exit branch 1205 after layer 4 of the main branch. In the example shown in FIG. 12, it is assumed that both that second exit branch 1205 and layer 5 of the main branch of the neural network are distributed over the execution engines of the NPU 306, with the exit branch 1205 being processed by one execution engine of the NPU 306, and the remaining execution engines being used for the main branch layer 5 processing.

Following layer 5 of the main branch processing, there is then a further exit branch 3 1206. In this case again, that third exit branch is performed using one execution engine of the NPU 306, with the main branch layer 6 processing being performed on the other execution engines of the NPU 306.

Finally, any layer 7 main branch processing is performed using the execution engines of the NPU 306.

In the arrangement shown in FIG. 12, the main branch and exit branch processing is performed simultaneously (albeit potentially distributed across the different processors of the system). FIG. 13 shows an alternative arrangement where the layer 5 main branch processing 1207 and the second exit branch processing 1205 are not performed simultaneously, but rather are performed one after another on the NPU 306.

Other arrangements for the distribution, sequencing and timing of the various neural network processing operations would, of course, be possible.

Various modifications, changes and additions to the described embodiments would be possible, if desired.

For example, the selection of which branch to use may also be based on the available hardware for executing the neural network processing of the branch or branches. In this regard, it would be possible to configure branches in the neural network that are more optimised for particular forms of hardware (e.g. in terms of their processing resources, memory resources, etc.). In that case, it could be identified what hardware is available for executing the different branches of the neural network, and the branch to use selected, at least in part, based on the hardware that is available for its execution in the system.

This could consider, for example, what forms of processor (processing unit) are available for executing the branches of the neural network and selecting the branch to use accordingly, and/or considering what processing hardware (e.g. functional units) an individual processor has available for executing the neural network processing (with the branch to use then being selected accordingly).

It would also correspondingly be possible to, once a branch of the neural network processing has been selected, select a processing resource to use to execute the selected branch of neural network processing based on the type of processing required for the selected branch and the processor/hardware resources available for performing the neural network processing. This could comprise selecting between different processors (e.g. an NPU and a GPU) for executing the selected branch, and/or selecting between different processing resources (processing circuits) of an individual processor for executing the branch.

The branch selection could also consider whether a (the) previous input (e.g. the previous frame) used a particular branch or not, and base the selection decision on that as well. For example, it could be determined whether a given region of the current output feature map from the layer preceding the branching point is sufficiently similar to that region of the feature map for a preceding input, and if so, the branch that was used previously could (preferentially) be selected.

In an embodiment, the result of processing (a region of) an output feature map via a particular branch is checked to determine if that processing was “successful” (e.g. and in an embodiment based on a measure of the accuracy of the processing by the branch, for example in terms of a confidence value for the result of that processing), and in the event that the processing via the particular branch is determined not to be “successful” (e.g. the confidence value for the processing via that branch is too low (is below a threshold confidence value), then the processing of the region of the output feature map that was processed using the particular branch is repeated using another one of the branches of the neural network processing available at the branching point in question.

This will then provide a “sense check” on whether it was appropriate to process the region of the output feature map using the initially selected branch of neural network processing.

It would also be possible, for example, to periodically disable the branching operation and simply execute the “full” neural network processing for a given input, and then compare the result of that “full” processing with the result obtained for the same or other inputs using the branching configuration, to determine whether the branching operation is providing suitable (e.g. sufficiently accurate) results or not. For example, when processing frames of video using a neural network, the results of previous and current frames could be compared for accuracy, and/or the same frame could be processed solely using the “full” network and using the “branching” network and the results compared. Other arrangements would, of course, be possible.

It can be seen from the above that the technology described herein, in its embodiments at least, can provide for more efficient neural network processing. This is achieved, in the embodiments of the technology described herein at least, by providing a neural network comprising one or more branching points, and selecting the branch to take at a branching point based on a property or properties of the output feature map from the layer of neural network processing preceding the branching point. The branch selection may also, for example, be based on the particular hardware available for performing the neural network processing in the data processing system in question.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

What is claimed is:

1. A method of operating a data processing system, the data processing system comprising one or more processors operable to execute neural network processing, and memory for storing data relating to the neural network processing being performed by the one or more processors, the method comprising:
one or more of the one or more processors executing a neural network comprising a sequence of plural layers of neural network processing to process an initial input data set to generate a final output data set that is the result of processing the initial input data set using the neural network;
wherein:
at least one of the layers of the sequence of plural layers of the neural network is followed by two or more branches of neural network processing, each branch comprising a different sequence of one or more layers of neural network processing, whereby the neural network processing from the layer that is followed by two or more branches of neural network processing onwards can be selectively performed via one or more of the different branches of neural network layers;
the method further comprising, when executing the neural network:
for a layer of the neural network that is followed by two or more branches of neural network processing, selecting the branch or branches to use for the neural network processing from that layer onwards based on a property or properties of the output feature map from the layer that is followed by the two or more branches.

2. The method of claim 1, wherein:
all the branches of neural network processing perform the same overall processing operation; and
one of the branches is a primary branch of neural network processing that is relatively more complex in terms of the neural network processing that it performs;
and another of the branches is a secondary branch of neural network processing that is relatively simpler in terms of the neural network processing that it performs.

3. The method of claim 1, comprising:
processing the output feature map from the layer that is followed by the two or more branches as a plurality of separate parts that each comprise some but not all of the output feature map; and
for each part of the output feature map, selecting the branch to use for the neural network processing for that part of the output feature map based on a property or properties of that part of the output feature map.

4. The method of claim 1, wherein the property that the selection of the branch to use is based on comprises a measure of the variability of data values in the output feature map.

5. The method of claim 1, wherein the property that the selection of the branch to use is based on comprises a measure of the relative compressibility of some or all of the output feature map.

6. The method of claim 1, comprising using metadata for the output feature map as a measure of the property or properties that the selection of the branch to use is based on.

7. The method of claim 1, comprising:
selecting the branch or branches to use for the neural network processing based on a property or properties of the output feature map, together with one or more further conditions or criteria.

8. The method of claim 1, comprising:
selecting the branch or branches to use for the neural network processing based on a measure of the relative cost between processing all of the output feature map down the same, single branch, and processing different parts of the output feature map down different branches.

9. The method of claim 1, further comprising, once a branch of the neural network processing has been selected, selecting a processing resource to use to execute the selected branch of neural network processing based on the type of processing required for the selected branch.

10. A method of operating a data processing system, the data processing system comprising one or more processors operable to execute neural network processing, and memory for storing data relating to the neural network processing being performed by the one or more processors, the method comprising:
when executing on the one or more processors a neural network comprising:
a sequence of plural layers of neural network processing to process an initial input data set to generate a final output data set that is the result of processing the initial input data set using the neural network;
wherein:
at least one of the layers of the sequence of plural layers of the neural network is followed by two or more branches of neural network processing, each branch comprising a different sequence of one or more layers of neural network processing, whereby the neural network processing from the layer that is followed by two or more branches of neural network processing onwards can be selectively performed via one or more of the different branches of neural network layers:
for a layer of the neural network that is followed by two or more branches of neural network processing, selecting the branch or branches to use for the neural network processing from that layer onwards based on an available processing resource of the one or more processors for performing the neural network processing.

11. A data processing system, the data processing system comprising:
one or more processors operable to execute neural network processing;
memory for storing data relating to the neural network processing being performed by the one or more processors; and
a processing circuit configured to:
when one or more of the one or more processors is executing a neural network comprising a sequence of plural layers of neural network processing to process an initial input data set to generate a final output data set that is the result of processing the initial input data set using the neural network, and
at least one of the layers of the sequence of plural layers of the neural network is followed by two or more branches of neural network processing, each branch comprising a different sequence of one or more layers of neural network processing, such that the neural network processing from the layer that is followed by two or more branches of neural network processing onwards can be selectively performed via one or more of the different branches of neural network layers:
select the branch or branches of neural network processing to use for the neural network processing following a layer of a neural network that is followed by two or more branches of neural network processing, based on a property or properties of the output feature map from the layer that is followed by the two or more branches of neural network processing.

12. The system of claim 11, wherein:
all the branches of neural network processing perform the same overall processing operation; and
one of the branches is a primary branch of neural network processing that is relatively more complex in terms of the neural network processing that it performs;
and another of the branches is a secondary branch of neural network processing that is relatively simpler in terms of the neural network processing that it performs.

13. The system of claim 11, wherein the processing circuit is configured to:
cause the output feature map from the layer that is followed by the two or more branches to be processed as a plurality of separate parts that each comprise some but not all of the output feature map; and
for each part of the output feature map, select the branch to use for the neural network processing for that part of the output feature map based on a property or properties of that part of the output feature map.

14. The system of claim 11, wherein the property that the selection of the branch to use is based on comprises a measure of the variability of data values in the output feature map.

15. The system of claim 11, wherein the property that the selection of the branch to use is based on comprises a measure of the relative compressibility of some or all of the output feature map.

16. The system of claim 11, wherein the processing circuit is configured to use metadata for the output feature map as a measure of the property or properties that the selection of the branch to use is based on.

17. The system of claim 11, wherein the processing circuit is configured to:
select the branch or branches to use for the neural network processing based on a property or properties of the output feature map, together with one or more further conditions or criteria.

18. The system of claim 11, wherein the processing circuit is configured to:
select the branch or branches to use for the neural network processing based on a measure of the relative cost between processing all of the output feature map down the same, single branch, and processing different parts of the output feature map down different branches.

19. The system of claim 11, wherein the processing circuit is configured to:
once a branch of the neural network processing has been selected, select a processing resource to use to execute the selected branch of neural network processing based on the type of processing required for the selected branch.

20. A non-transitory computer readable storage medium storing computer software code which when executing on one or more processors performs a method of generating a neural network that can be executed by one or more processors to perform neural network processing, the method comprising:
generating a neural network comprising:
a sequence of plural layers of neural network processing to process an initial input data set to generate a final output data set that is the result of processing the initial input data set using the neural network;
wherein:
at least one of the layers of the sequence of plural layers of the neural network is followed by two or more branches of neural network processing, each branch comprising a different sequence of one or more layers of neural network processing, whereby the neural network processing from the layer that is followed by two or more branches of neural network processing onwards can be selectively performed via one or more of the different branches of neural network layers;
the method further comprising:
for at least one set of two or more branches of neural network processing that follow a layer of the sequence of plural layers of the neural network:
configuring one of the branches of neural network processing for processing on a first type of processing resource; and
configuring another one of the branches of neural network processing for processing on a second, different type of processing resource.
